(19) United States
(12) Patent Application Publication
(10) Pub. No.: US 2014/0074572 A1
(43) Pub. Date: Mar. 13, 2014

(54) INFORMATION AND PROFIT SHARING ON A SOCIAL NETWORKING SYSTEM

(71) Applicant: Christopher David Bell, Athens, GA (US)

(72) Inventor: Christopher David Bell, Athens, GA (US)

(21) Appl. No.: 13/610,428

(22) Filed: Sep. 11, 2012

(51) Int. Cl. G06Q 30/02

(52) U.S. Cl. 705/14.7; 705/14.69

(57) ABSTRACT

Systems and methods for allowing users to create objects for a particular area of interest(s) on a social networking system through one or more web-based templates, and allowing such users to share in profits generated from the creation of such objects. A plurality of resource objects are maintained on a social networking system. One or more web-based templates are provided on a communications device of a host or partner for generation of resource objects. The web-based templates allow customization of real-time interface components displayed to end-users. The social networking system provides access of resource objects to end-users through the one or more real-time interface components. The social networking system determines profits generated for the resource objects, and determines the amount payable to the host creating the resource object.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction anyone of the patent disclosure as it appears in the Patent and Trademark Office patent files or records, but otherwise reserves all copyright and trade dress rights whatsoever.

### BACKGROUND

Social networking systems may communicate connections amongst users sharing common interests or activities. Such social networking systems are accessible to users by computer or other device. Social networking systems are most often web-based. Such social networking systems may allow users to interact, such as by emails, posting blogs, posting comments, or photos to other users.

A user of a social networking website may supply information concerning an event or group viewable by other users of the social networking website. However, users must often be associated with other users to view content relating to such an event or group. Moreover, customization and integration of real-time interface components may be limited by such systems and may not allow the host to choose which components to be displayed to other users. Additionally, users who create the event or group may not be afforded the opportunity to capitalize on a share of the sponsorship and advertising profit through their efforts of developing and providing the relevant content on the event/establishment sites. Therefore, a need exists for systems and methods allowing users to create objects for a particular area of interest(s) on a social networking system through one or more web-based templates, and to allow such users to share in profits generated from the creation of such objects.

### SUMMARY

The present invention is directed to systems and methods which allow users to create objects for a particular area of interest(s) on a social networking system through one or more web-based templates, and to allow such users to share in profits generated from the creation of such objects.

According to embodiments, a user may choose to associate with a number of resource objects (events, groups, establishments, or other users) maintained on the social networking system. A user can choose to be a host on the social networking system and may create an event, group, or establishment on the social networking system via one or more web-based templates displayed on a communications device of the host. The web-based templates allow the host to customize the number, type, and arrangement of real-time interface components displayed on a website. The website is accessible on communications devices of other users who can provide content and interact with the website. Each resource object created by the host may have sponsorships, advertising, and partnerships which may provide revenue for a particular resource object. The social networking system determines the profit attributable to each resource object maintained. The social networking system then determines the amount to be paid to the host for creation of the event, group, or establishment on the social networking system.

In a preferred embodiment, the social networking system receives resource information via a plurality of web-based templates displayed on a communications device of the host. One or more partners may also associate with a resource object on the social networking system and may pay a subscription fee. The social networking system receives amended resource information from the partner via a plurality of web-based templates displayed on a communications device of the partner. The social networking system provides user generated websites on a communications device of an end-user based on information obtained via the web-based templates which are stored on one or more databases on the social networking system. The web-based templates are interactive graphical user interfaces (GUIs) which allow for customization of the number, type, and arrangement of real-time interface components displayed on the website for a particular resource object. The social networking system provides access for end-users to access resource objects through the websites. The end-user may provide content data concerning the resource object on social networking system. The content data is viewable to other end-users on the social networking system. The social networking system allows one or more advertisers to associate with the resource objects maintained on the social networking system and to pay for advertising. The social networking system also allows one or more sponsors to associate with the resource objects maintained on the social networking system and to pay for sponsorships. The social networking system determines profit generated from sponsorship and advertising for a particular resource object. The social networking system determines percentage of profit to be paid to a host creating the resource object.

Resource objects are data objects maintained on the social networking system which represent either of: events, groups, establishments, or users. Resource objects can be associated with other resource objects on the social networking system.

An event host on the social networking system can create event(s) in his or her own geographical area (city/town/zip code). An event relates to a real-time occurrence or gathering. An event may be a sub-event (a football game watch party may be a sub-event of the football game itself, i.e. a vertical relationship). Events or sub-events may also be related to other events or sub-groups (football game watch parties may all be sub-events of the football game itself—i.e. a horizontal relationship). Events are associated with other events in the geographical area upon consent of both event hosts (i.e. explicit consent model).

A group host is also allowed to create a group in his or her own geographical area (city/town/zip code). A group relates to a group of individuals surrounding a common interest. An group may be sub-groups (i.e. local fraternity may be a sub-group of the national fraternity).

An establishment host is allowed to create an establishment in his or her own geographical area (city/town/zip code). An establishment is related to a physical location, such as a restaurant, for example. Establishments may be sub-establishments (i.e. a local restaurant may be a sub-establishment of a national chain). A partner may also choose to associate with an establishment and provide amended content data.

Events, groups, and establishments are created by the hosts (event hosts, group hosts, or establishment hosts) entering relevant information into one or more web-based templates displayed on communications devices of the hosts. The web-based templates allow customization and display of real-time interface components on websites which are viewable by end users on their communication devices. The real-time interface components may be widgets, blog applications, picture posting applications, posting applications, and similar interactive components.

Sponsors bid on sponsorship placeholders displayed on the website of a particular resource object. Advertisers can also bid on opportunities to advertise their products/services on the website of a particular resource object.

Resource object creation through web-based templates allow hosts who have no knowledge of web or coding to create, display, and profit from websites that promote the events, establishments, and/or groups they create. Hosts provide the resource information and choose the layout to be provided to end-users. Sponsorships and advertising generates revenues for the events, groups, and establishments created, and are driven by the amount of traffic generated by the event, group, or establishment. Accordingly, users are incentivized to become hosts and upload content concerning an event, group, or establishment on the social networking system.

### BRIEF DESCRIPTION OF THE DRAWINGS

These and other features, aspects and advantages of embodiments of the invention will become better understood with regard to the following description, appended claims, and accompanying drawings where:

FIG. 1 is a flow diagram of an exemplary process for information and profit sharing a social networking system;

FIG. 2 is a relationship diagram showing supplied data defining a resource object on the social networking system;

FIG. 3 illustrates information stored in a resource object maintained on the social networking system;

FIG. 4 is a screenshot of an event information entry step, according to the embodiment of FIG. 1;

FIG. 5 is a screenshot of an event formatting information entry step, according to the embodiment of FIG. 1;

FIG. 6 is a screenshot of an event widget selection entry step, according to the embodiment of FIG. 1;

FIG. 7 is a screenshot of an event external blog information entry step, according to the embodiment of FIG. 1;

FIG. 8 is a screenshot of an event message board content information entry step, according to the embodiment of FIG. 1;

FIG. 9 is a screenshot of an event important links information entry step, according to the embodiment of FIG. 1;

FIG. 10 is a screenshot of an event associations entry step, according to the embodiment of FIG. 1;

FIG. 11 is a screenshot of an establishment information entry step, according to the embodiment of FIG. 1;

FIG. 12 is a screenshot of an establishment secondary information bar entry step, according to the embodiment of FIG. 1;

FIG. 13 is a screenshot of an establishment slideshow information entry step, according to the embodiment of FIG. 1;

FIG. 14 is a screenshot of a menu information entry step, according to the embodiment of FIG. 1;

FIG. 15 is a screenshot of an hours of operation information entry step, according to the embodiment of FIG. 1;

FIG. 16 is a screenshot of an establishment external blog information entry step, according to the embodiment of FIG. 1;

FIG. 17 is a screenshot of an establishment message board content information entry step, according to the embodiment of FIG. 1;

FIG. 18 is a screenshot of an establishment important links information entry step, according to the embodiment of FIG. 1;

FIG. 19 is a screenshot of a partner information entry step, according to the embodiment of FIG. 1;

FIG. 20 is a screenshot of a coupons information entry step, according to the embodiment of FIG. 1;

FIG. 21 is a screenshot of a special offerings entry step, according to the embodiment of FIG. 1;

FIG. 22 is a screenshot of a calendar of events entry step, according to the embodiment of FIG. 1;

FIG. 23 is a screenshot of an event user display interface, according to the embodiment of FIG. 1;

FIG. 24 is a screenshot of an event slideshow section, according to the embodiment of FIG. 1;

FIG. 25 is a screenshot of an event widget section, according to the embodiment of FIG. 1;

FIG. 26 is a screenshot of an establishment user display interface, according to the embodiment of FIG. 1;

FIG. 27 is a screenshot of an establishment top banner, according to the embodiment of FIG. 1;

FIG. 28 is a screenshot of an establishment slideshow section, according to the embodiment of FIG. 1;

FIG. 29 is a screenshot of a secondary information bar, according to the embodiment of FIG. 1;

FIG. 30 is screenshot of a menu section, according to the embodiment of FIG. 1;

FIG. 31 is a screenshot of coupons section, according to the embodiment of FIG. 1;

FIG. 32 is a screenshot of a special offerings section, according to the embodiment of FIG. 1;

FIG. 33 is a screenshot of an hours of operation section, according to the embodiment of FIG. 1;

FIG. 34 is a screenshot of an establishment location section, according to the embodiment of FIG. 1;

FIG. 35 is a screenshot of a comments section, according to the embodiment of FIG. 1;

FIG. 36 is a screenshot of a ratings section, according to the embodiment of FIG. 1;

FIG. 37 is a screenshot of a calendar of events section, according to the embodiment of FIG. 1;

FIG. 38 is a screenshot of a group user display interface, according to the embodiment of FIG. 1;

FIGS. 39-41 are a screenshots of a resource display interface, according the embodiment of FIG. 1;

FIG. 42 is a screenshot of a buzz section, according to the embodiment of FIG. 1;

FIG. 43 is a screenshot of a blog section, according to the embodiment of FIG. 1;

FIG. 44 is a screenshot of a best of the best section, according to the embodiment of FIG. 1;

FIG. 45 is a screenshot of an information section, according to the embodiment of FIG. 1;

FIG. 46 is a screenshot of an advertisement section, according to the embodiment of FIG. 1;

FIG. 47 is a screenshot of a user profile interface, according to the embodiment of FIG. 1;

FIG. 48 is a screenshot of a search interface, according to the embodiment of FIG. 1;

FIG. 49 is a screenshot of a calendar interface, according to the embodiment of FIG. 1;

FIG. 50 is a high-level diagram of an exemplary system for providing real-time notification of increased communication in a selected area of interest on a social networking system showing interaction between communications devices of a host, partner, and user with a social networking system;

FIG. 51 is a schematic diagram of an exemplary social networking system; and

FIG. 52 is a schematic diagram of detailed view of an exemplary hardware implementation of the social networking system.

### DESCRIPTION

### Definitions

Resource objects herein refer to data objects pertaining to events, groups, users and/or establishments on the social networking system. Resource objects may include resource information, amended resource data, content data, and resource object associations. Resource objects can be classified by type. For example, resource objects may be event types, bar types, restaurant types, and/or retail store types. Each type may be further subdivided into a class. Examples of classes of resource objects may include tail-gate, bar, play-off, wedding, seminar, wine bar, fraternity, and the like.

Resource objects can be associated with other resource objects on the social networking system. For example, an event may be associated with establishments, events, or groups relevant to the event. Resource objects can also be associated with sub-resources. For example, an event could have a sub-event. Resource objects may maintain a horizontal and/or vertical relationship with other resource objects on the social networking system.

A user can interact with the social networking system through a communications device and choose to be a host of a resource object. The host creates an event, group, or establishment on the social networking system.

A user can choose to be a partner of a resource object. One or more partners can associate with the resource object. A partner can access resource objects after creation by the host. For example, a partner may be an owner/operator of an establishment.

“End-users” defines a user on the social networking system who is capable of accessing and providing content data to resource objects via real-time interface components on the websites generated by the user-based templates.

Resource information refers to data relevant to the event, group, or establishment, provided by the host. Resource information for example can be an event name, an event start date, event end date, and similar information. Resource information also contains information detailing how the website generated by the web-based templates is to be displayed to an end-user. For example, a host can select the number and type real-time interface components including of widgets, chat applications, or posting message boards which can be displayed on the websites generated by the web-based templates.

Amended resource information refers to data relevant to the event, group, or establishment, provided by a partner. Amended resource information can be menu information, a logo image, coupons, and hours of operation in the case of a restaurant (establishment) resource object.

Content data refers to real-time data provided by end-users relating to the resource object on the social networking system. Content data may be supplied via real-time interface components on the websites generated by the web-based templates. Content data may include for example video or audio clips, images, comments, status messages, blog entries, URL links, and/or ratings and review.

User resource object associations herein refers to the numerical value of resource objects a user has chosen to be associated with. For example, a user may choose to follow a football game watch party (event), a fraternity (group), and Italian restaurant (establishment). The number of user resource object associations would be three (3).

### DETAILED DESCRIPTION OF A PREFERRED EMBODIMENT

The following describes an example of an embodiment of the invention in a preferred embodiment. The described features, structures, or characteristics of the embodiment may be combined in any suitable manner in one or more embodiments. In the following description, numerous specific details are recited to provide a thorough understanding of embodiments of the invention. One skilled in the relevant art will recognize however, that the invention may be practiced without one or more of the specific details, or with other methods, components, materials, and so forth. In other instances, well-known structures, materials, or operations are not shown or described in detail to avoid obscuring aspects of the invention.

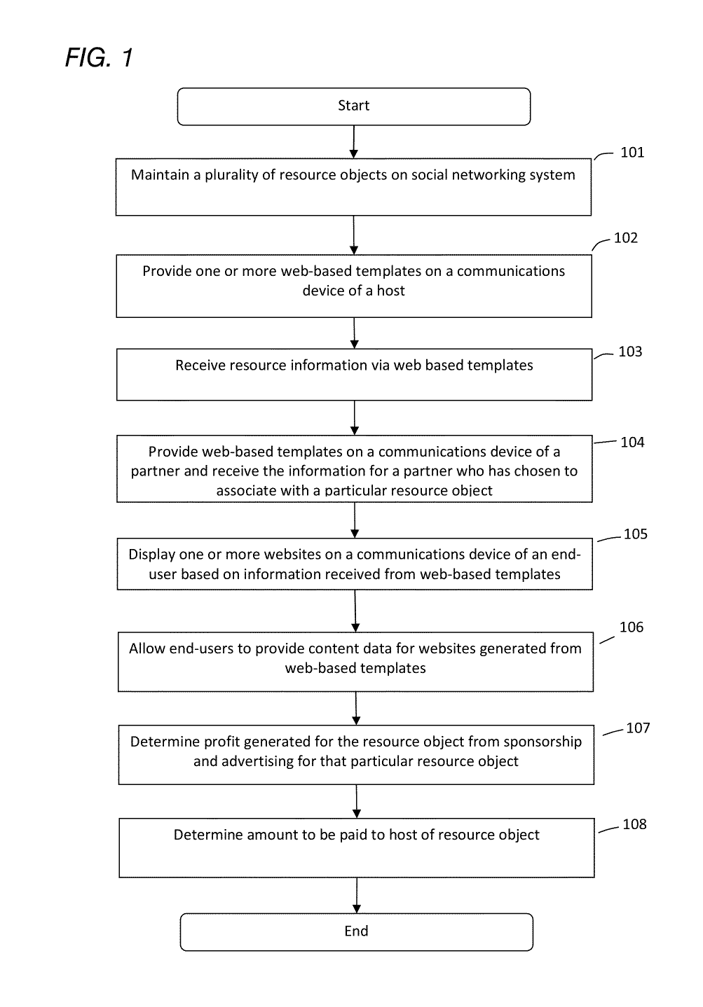

FIG. 1 illustrates a method for generating a customizable interface for creation of a group, event, or establishment based on information provided by users associated with a social networking system and allowing such users to share in revenue generated through sponsorships and advertising. A plurality of resource objects 202 are maintained 101 on a social networking system 201. One or more web-based templates are provided 102 on a communications device of a host 205c on the social networking system 201. The social networking system 201 receives 103 resource information 713 via the web-based templates. The social networking system provides 104 one or more web-based templates on a communications device of a partner 205b for receiving amended resource information 712 of a partner who has chosen to associate with the particular resource object 202. The social networking system 201 displays 105 one or more websites on a communications device of an end-user 105a based on information obtained in the web-based templates. The social networking system 201 provides 106 access for end-users to access resource objects 201 through the one or more real-time interface components. The social networking system determines 107 profit generated for the resource object 202 from sponsorship and advertising for that particular resource object 202. The social networking system determines 108 the amount to be paid to a host creating the resource object 202.

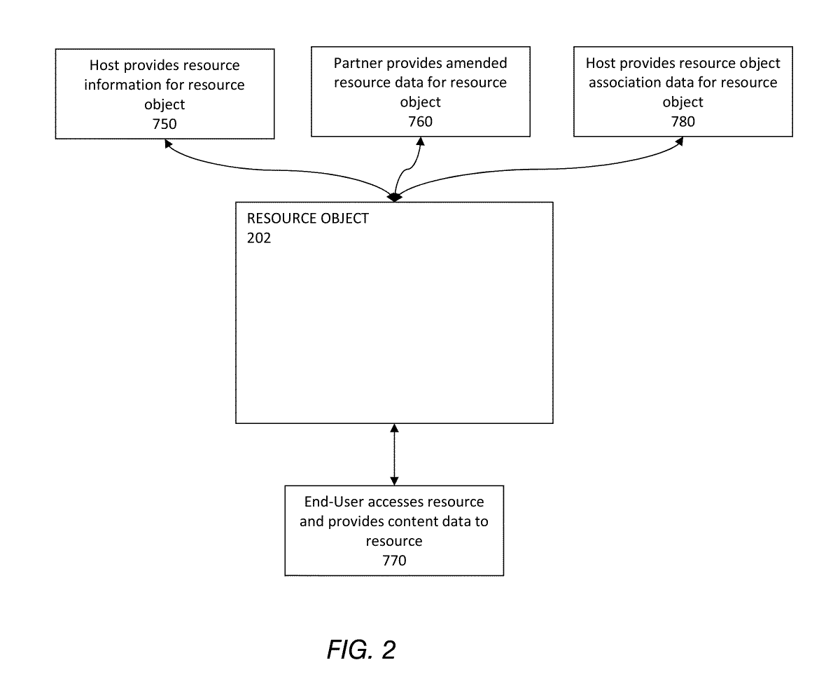

FIG. 2 illustrates a relationship diagram showing supplied data defining a resource object 202 maintained 101 on the social networking system 201. As shown, the host provides resource information 713 at 750. A partner provides amended resource information 712 at 760. A user accesses the resource object 202 and provides content data 711 at 770. The host can choose to associate the resource object 202 with other resource objects maintained on the social networking system 201 at 280.

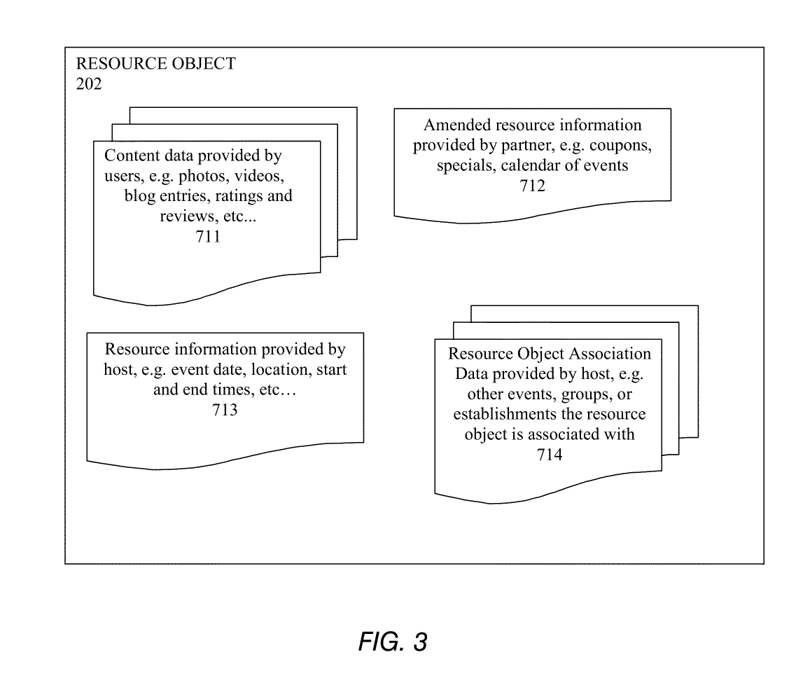

FIG. 3 illustrates information stored in a resource object 202 maintained 101 on the social networking system 201. As shown, resource objects 201 are comprised of content data 711, amended resource information 712, resource information 713, and resource object associations 714.

One or more web-based templates are provided 102 on a communications device of a host 205c on the social networking system 201 for creation of a resource object 202. The web-based templates allow the host to enter resource information 713 about the event, group, or establishment, so as to save and publish the resource information 713 on the social networking system 201. The web-based templates also allow the host to select the number, placement, arrangement, and type of real-time interface components on the website generated by the web-based templates. Real-time interface components can be widgets, chat applications, photo posting applications, and message posting boards, for example. In this manner, the host has creative control over the type of interactive data displayed to an end-user viewing the website generated by the web-based templates. The host can also upload photos, supply start-and end times, and other interactive information which is capable of being displayed on a website. The host can navigate to different steps using previous and next buttons 350 provided at the bottom of the web-based template of the respective next step. Step markers 352 are indicated allowing the host to navigate between steps. If a save and publish selection 351 is selected, the resource object 202 will be saved on the social networking system 201 and will be viewable to end-users.

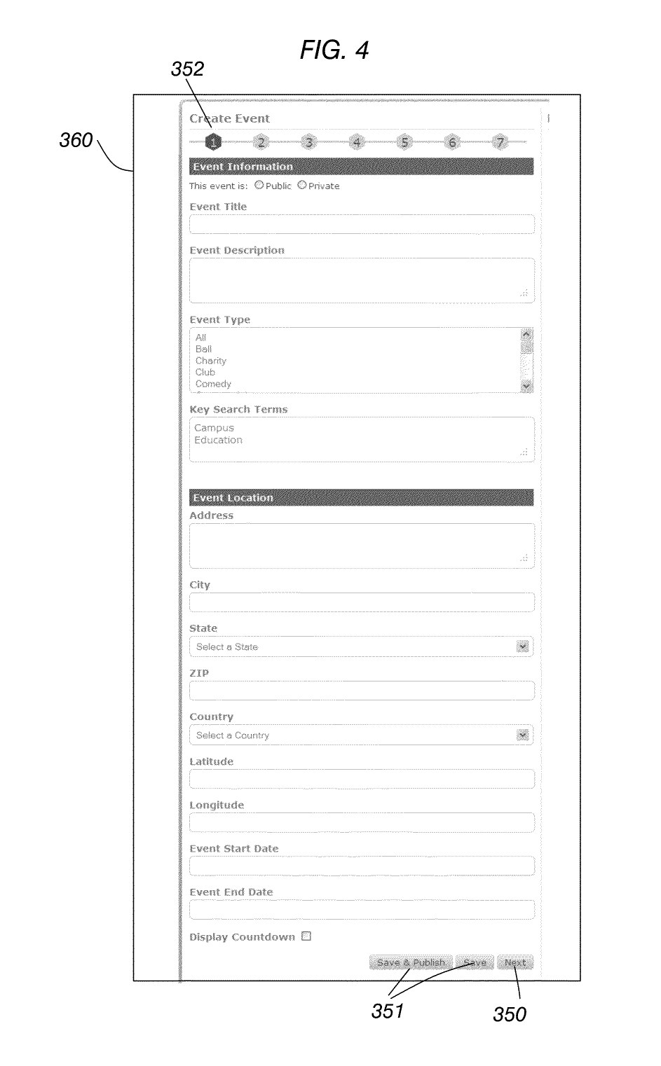

FIGS. 4-10 illustratively show screenshots of web-templates provided by the social networking system 201 for event creation by an event host in the preferred embodiment.

FIG. 4 illustrates a screenshot of an event information entry step 360. In this step, the event host has to fill in the minimum mandatory information so that the event is created and published on the social networking system 202. The event information entry step 360 may comprise the following data input parameters: an event public/private selection; an event title input box; an event description input box; an event type input box; a key search terms selection; an event location data group; a longitude input box; a latitude input box; an event start date input box; an event end date input box; and an event countdown input box.

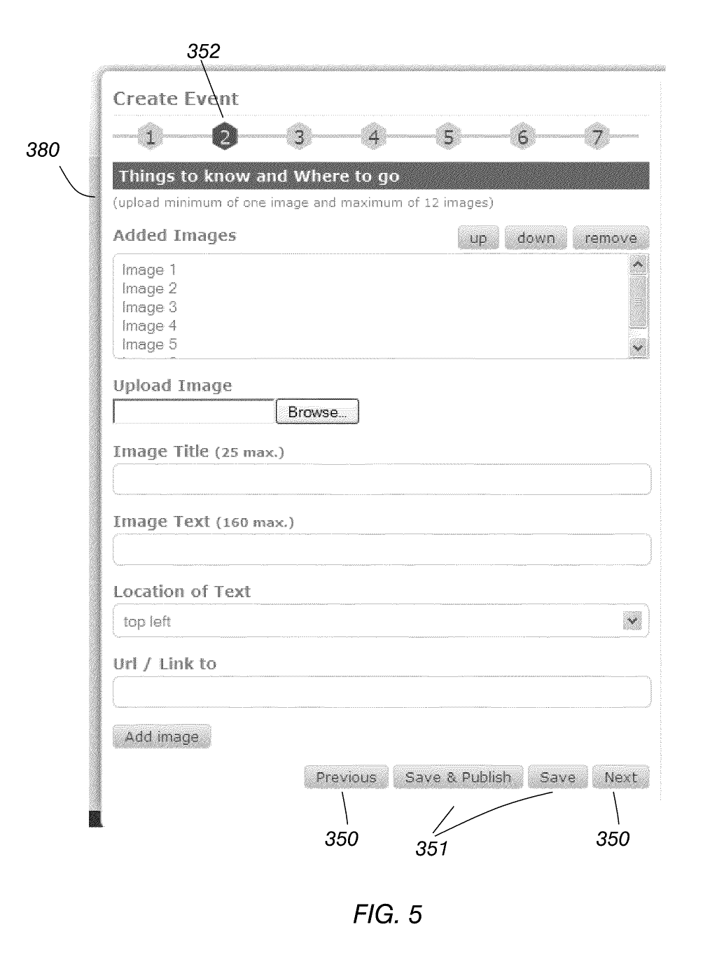

FIG. 5 illustrates a screenshot of an event formatting information entry step 380. In this step, the event host can provide formatting and visual data. The event formatting information entry step 380 may comprise the following data input parameters: added images data group; an image title input box; an image text input box; a location of text selection; and a URL display input box.

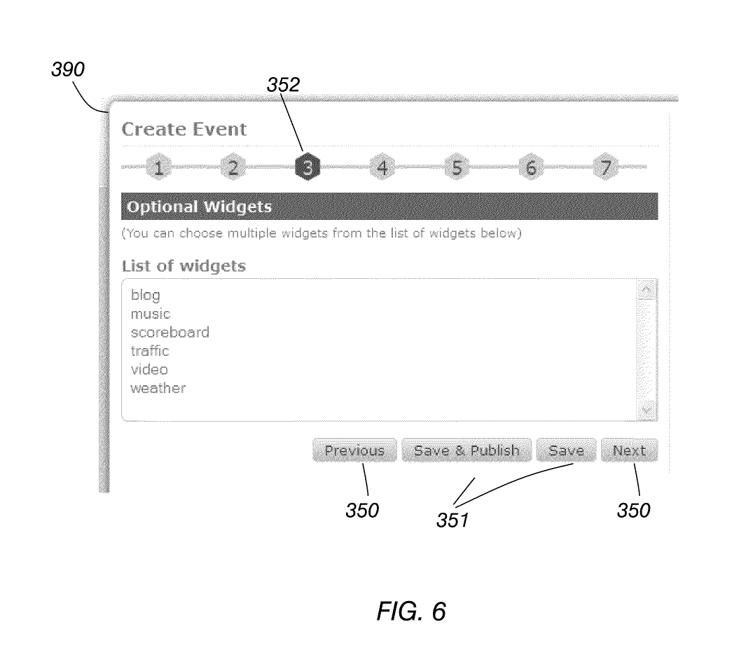

FIG. 6 illustrates a screenshot of an event widget selection entry step 390. In this step, the event host can choose multiple widgets to display for the event. The widget selection entry step may comprise a widget selection data group.

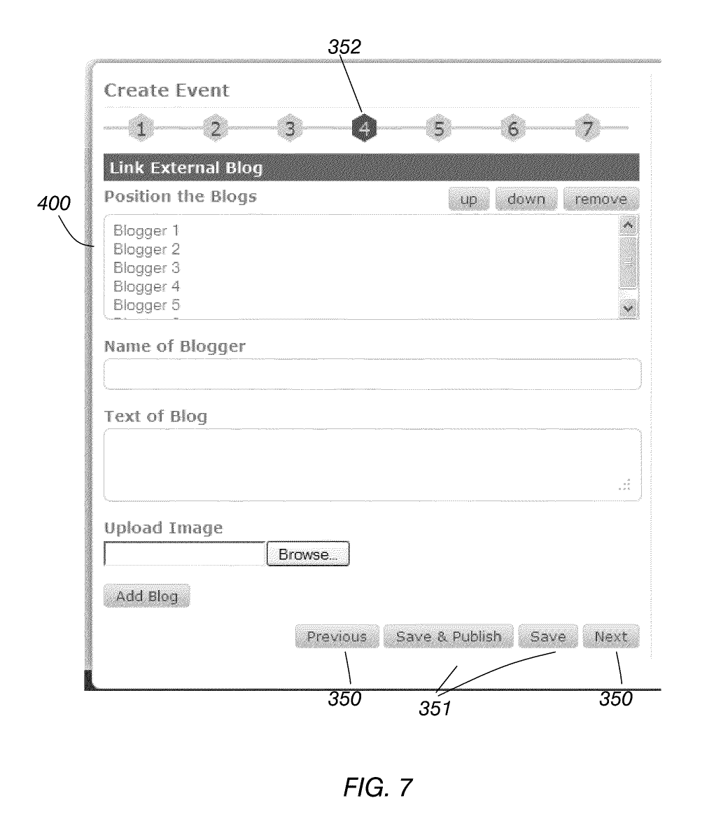

FIG. 7 illustrates a screenshot of an event external blog information entry step 400. In this step, the event host can add one or more links to external blogs. The event external blog information entry step 400 may comprise the following data input parameters: blogger name input box; and an upload image input box.

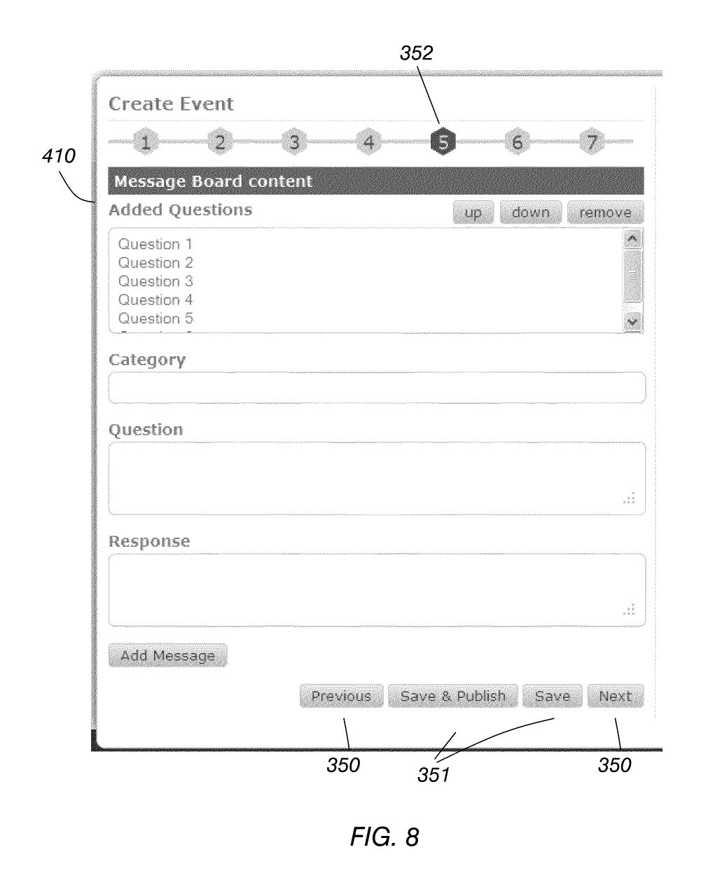

FIG. 8 illustrates a screenshot of an event message board content information entry step 410. In this step, the event host can add one or more question(s) and response(s). The event message board content information entry step 410 may comprise the following data input parameters: an added questions selection group; a category input box; a question input box; and a response input box.

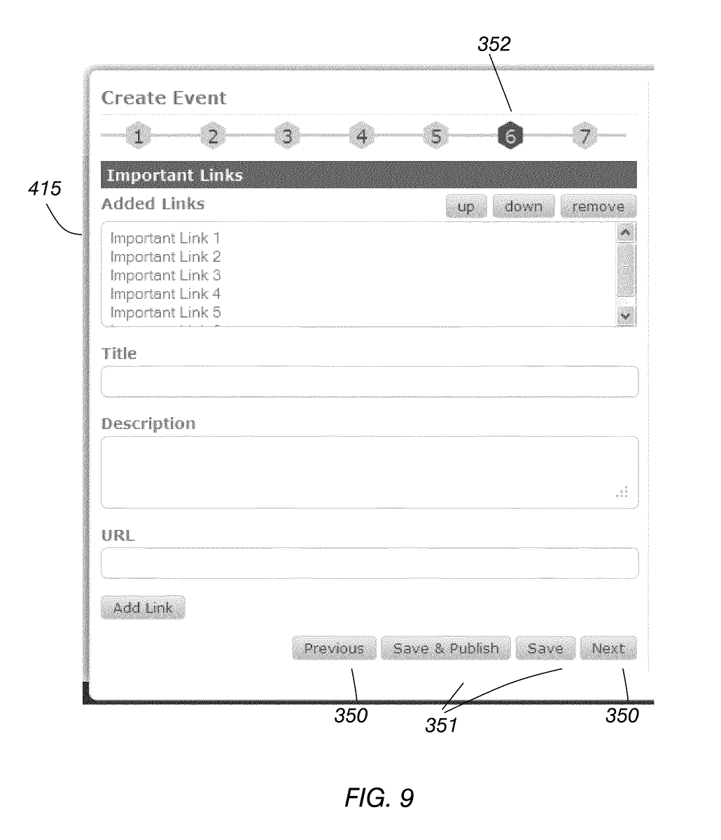

FIG. 9 illustrates a screenshot of an event important links information entry step 415. In this step the event host can add or more important links. The event important links information entry step 415 may comprise the following data input parameters: an added links selection group; a title input box; a description input box; and a URL input box.

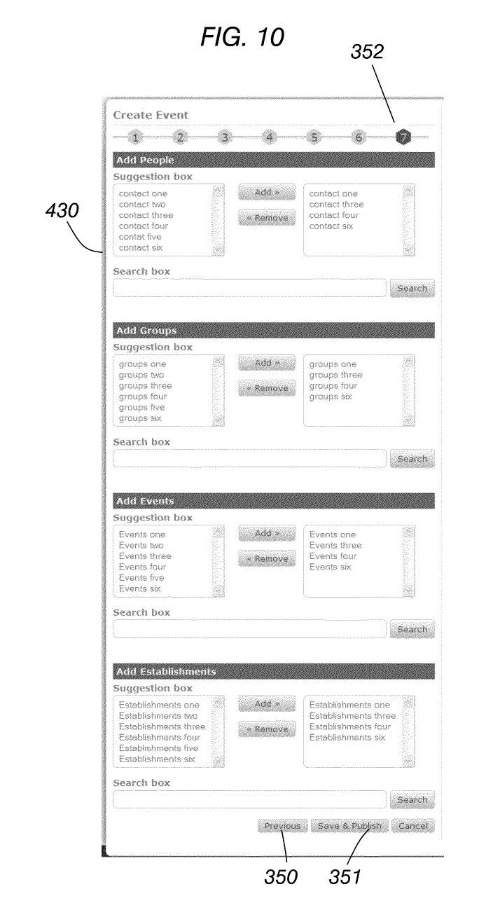

FIG. 10 illustrates a screenshot of an event associations information entry step 430. In this step, the event host can add people, groups, events and establishments to the event. The event message board information entry step 430 may comprise the following data input parameters: an added contact selection group; an added group selection group; an added event selection group; an added event selection group; an added establishment selection group; and one or more search input boxes. By default, the event associations information entry step 430 will display suggestion lists for people, groups, events and establishments to which the event host is already connected, if any.

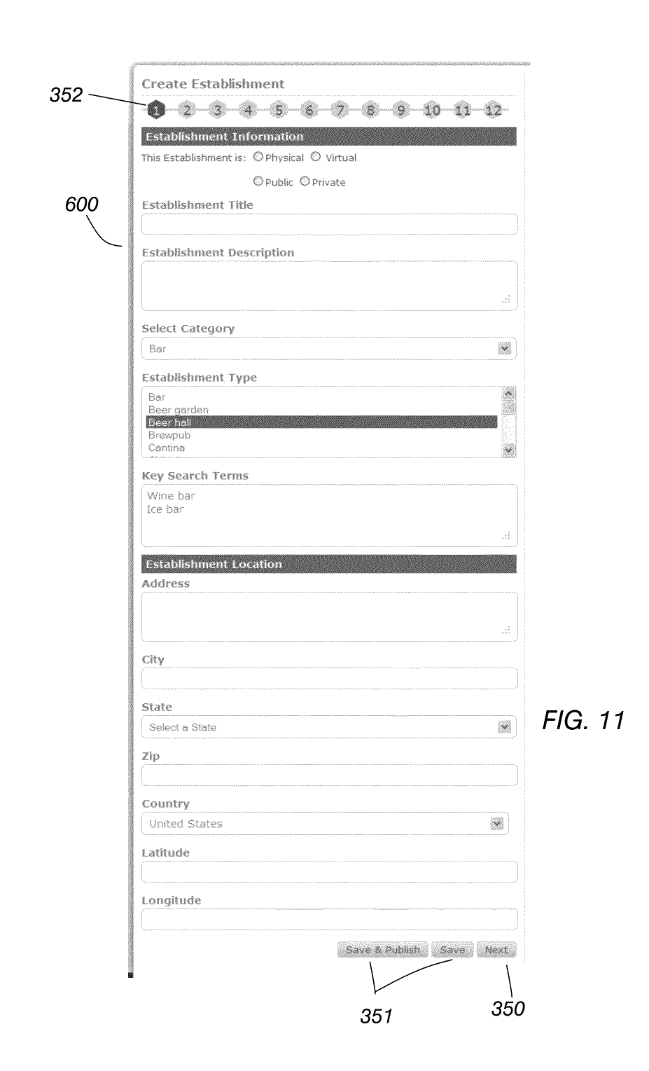

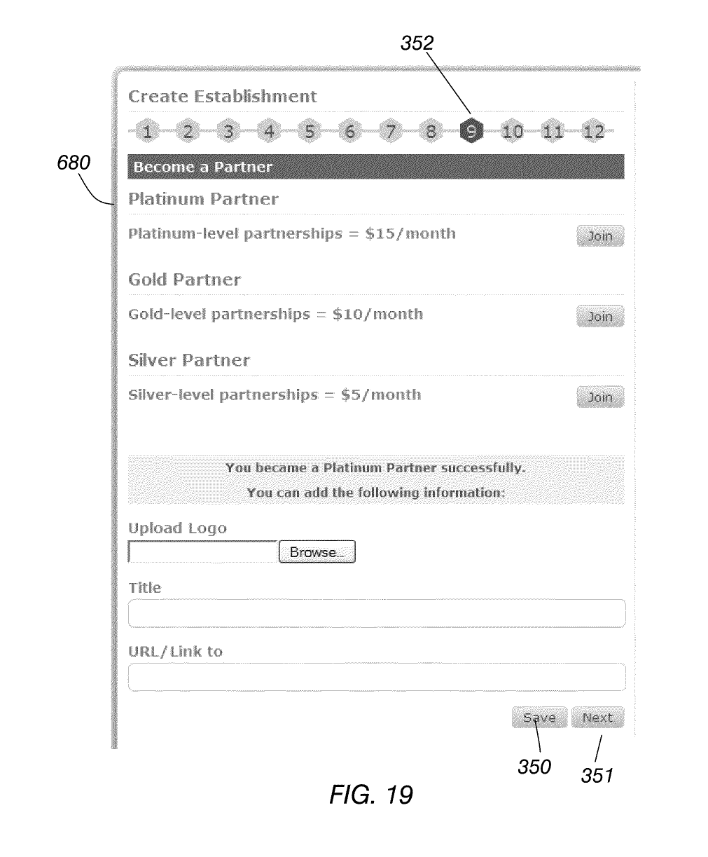

FIGS. 11-22 illustratively show screenshots of web-templates provided by the social networking system 201 for establishment creation by an establishment host in the preferred embodiment. As shown, creation of establishment contains a total of twelve (12) steps. Two separate processes of information entry are present for establishment creation: an establishment host provides for entry in steps 1-8 (as shown in FIGS. 11-18); one or more event partners provides for entry in steps 9-12 (as shown in FIGS. 19-22).

FIG. 11 illustrates a screenshot of the establishment information entry step 600. In this step, the establishment host has to fill in the minimum mandatory information so that the establishment is created and published on the social networking system 202. The establishment information entry step 600 may comprise the following data input parameters: an establishment public/private selection; an establishment title input box; an establishment description input box; an establishment category selection; an establishment type selection; an establishment key search terms selection; an establishment location data group; an establishment longitude input box; and an establishment latitude input box.

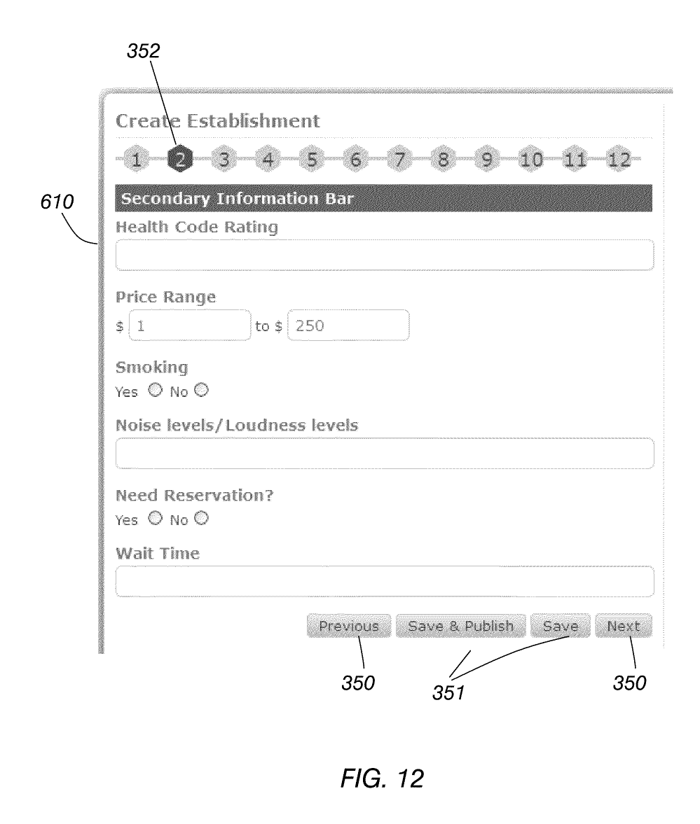

FIG. 12 illustrates a screenshot of an establishment secondary information bar entry step 610. In this step, the establishment host can provide information relating to the establishment. The establishment secondary information bar entry step 610 may comprise the following data input parameters: a health code rating input box; a price range data group; a smoking selection; a reservation needed selection; and a wait time input box.

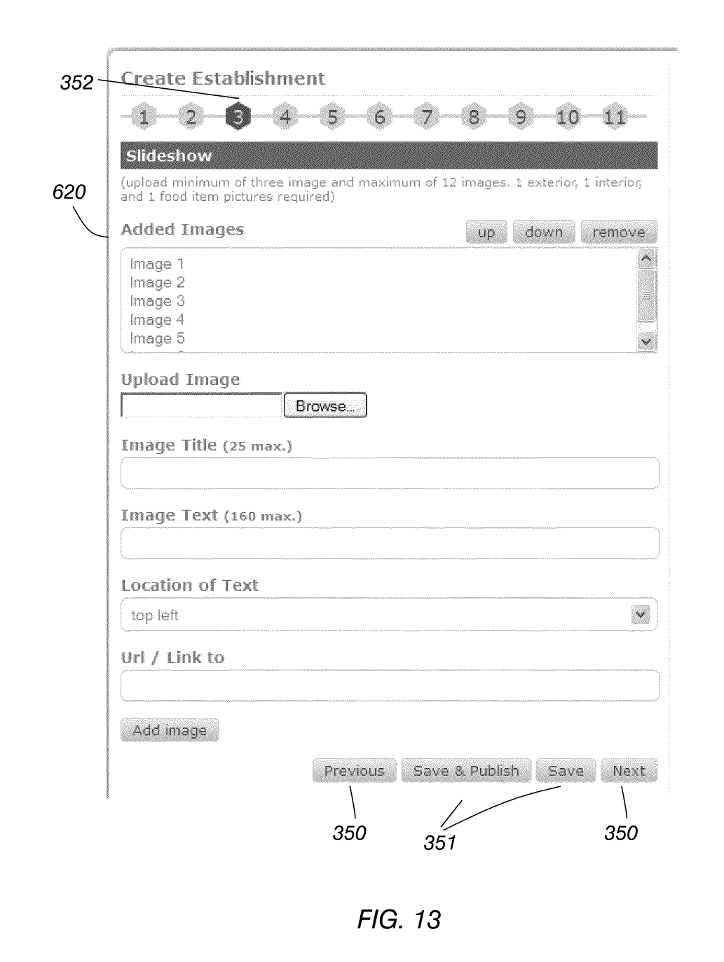

FIG. 13 illustrates a screenshot an establishment slideshow information entry step 620. In this step the establishment host can add one or more images relating to the establishment. The establishment slideshow information entry step 620 may comprise the following data input parameters: an added images selection group; an uploaded image selection; an image title input box; an image text input box; a location of text selection; and a URL input box.

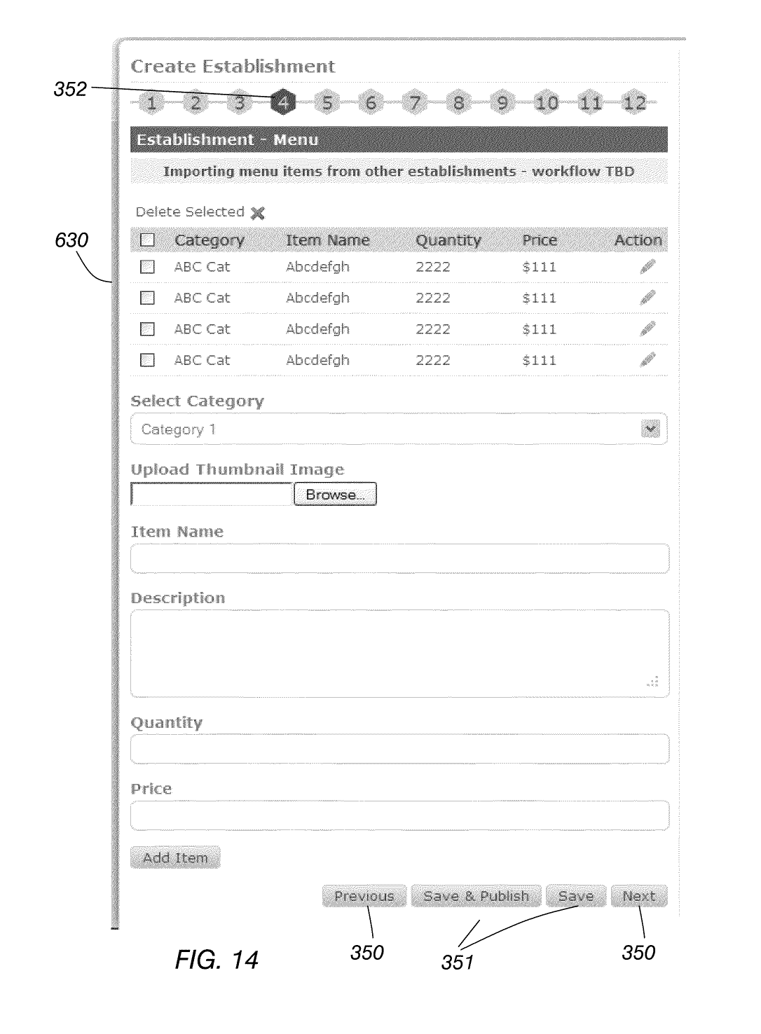

FIG. 14 illustrates a screenshot of a menu information entry step 630. In this step, the establishment host can create a list of items that are available at the bar/restaurant/retail store establishment. The establishment host can either import data from other establishments or can load the information manually. For manual entry, the menu information entry step may 630 comprise the following data input parameters: an establishment category selection; an establishment uploaded image input box; an item name input box; an item description box; an item quantity input box; and a price input box. The establishment host can add and remove one or more items.

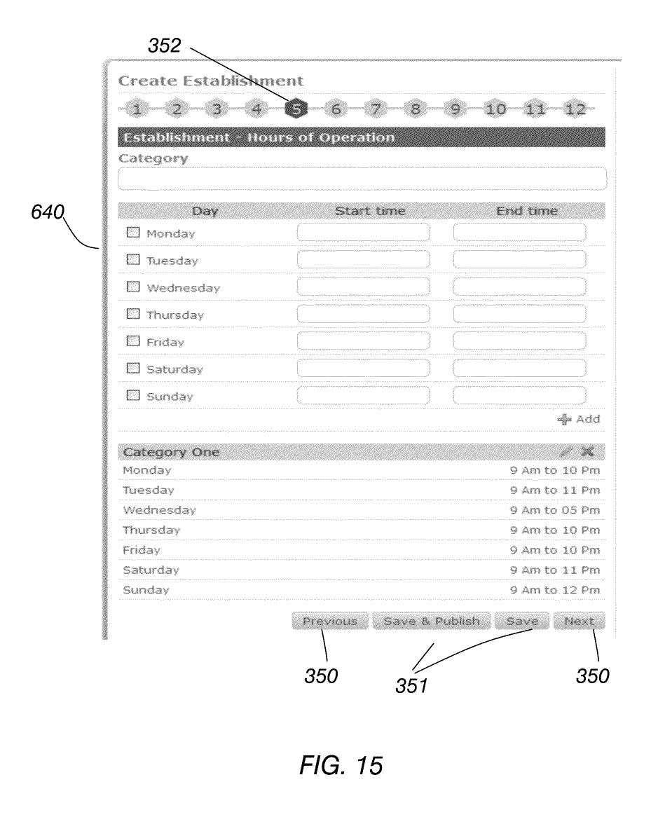

FIG. 15 illustrates a screenshot of an hours of operation information entry step 640. In this step, the establishment host can add the establishment hours of operation. The hours of operation can be added for different sections of an establishment working at differing timings. The hours of operation information entry step 640 may comprise the following data input parameters: an establishment category input box; and hours of operation selection group.

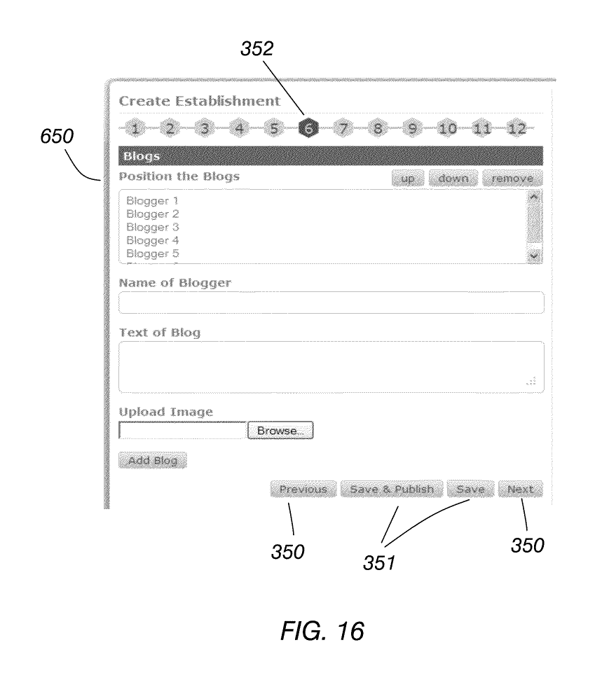

FIG. 16 illustrates a screenshot of an establishment external blog information entry step 650. In this step, the establishment host can add one or more links to external blogs. The external blog information entry step 650 may comprise the following data input parameters: blogger name input box; and an upload image input box.

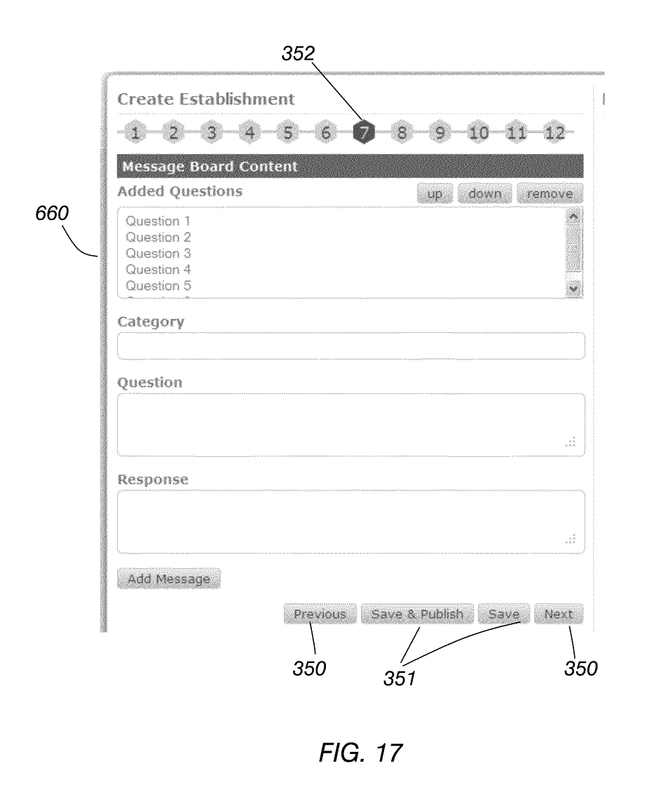

FIG. 17 illustrates a screenshot of an establishment message board content information entry step 660. In this step, the establishment host can add one or more question(s) and response(s). The message board information entry step 660 may comprise the following data input parameters: an added questions selection group; a category input box; a question input box; and a response input box. The establishment host can add one or more questions and set the display order by using the up, down buttons 303, 304. The establishment host can remove an added question entry by using the remove button 305.

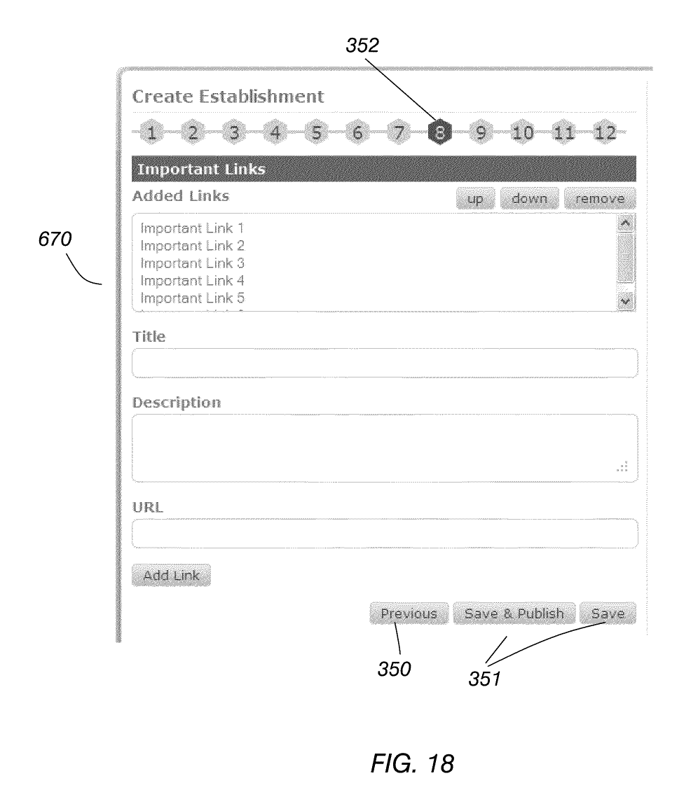

FIG. 18 illustrates a screenshot of a establishment important links information entry step 670. In this step, the establishment host can add or more important links. The important links information entry step 670 may comprise the following data input parameters: an added links selection group; a title input box; a description input box; and a url input box. The establishment host can add one or more important links and set the display order by using the up, down buttons 303, 304. The establishment host can remove an added important link entry by using the remove button 305.

One or more partners can be associated with an establishment maintained on the social networking system 201. In the preferred embodiment, partners may choose to associate by designating their association as a platinum partner, a gold partner, or a silver partner, and by paying a fee.

FIG. 19 illustrates a screenshot of a partner information entry step 680. In this step, an establishment host can become an establishment partner by choosing one of the three available partner options: platinum partner; gold partner; or silver partner. After the payment transaction is successful, the establishment partner is allowed to add additional information relating to the establishment. The partner information entry step 680 may comprise an establishment partner selection.

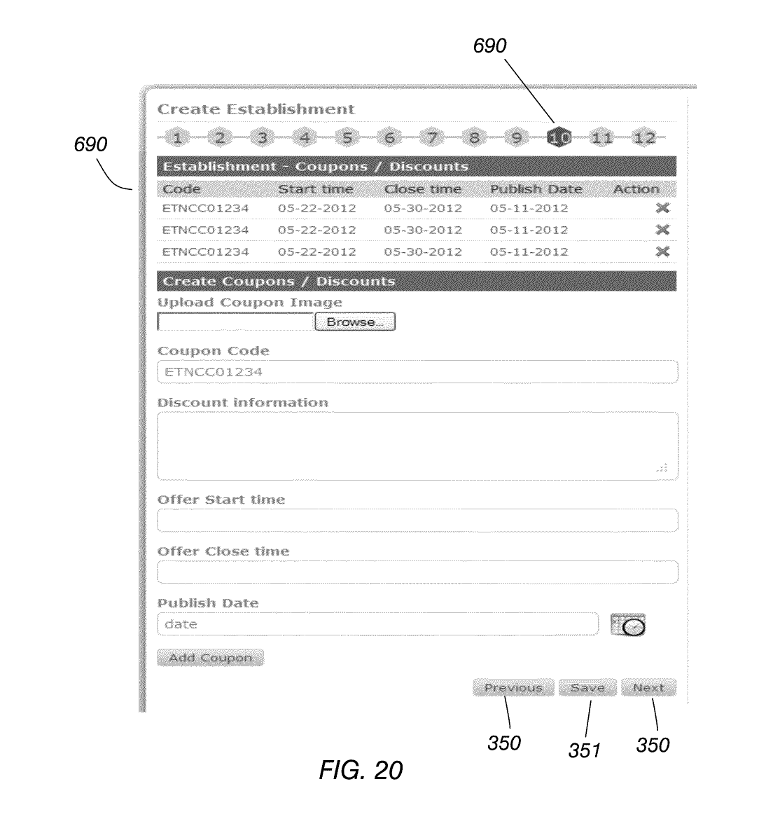

FIG. 20 illustrates a screenshot of a coupons information entry step 690. In this step, the establishment host or establishment partner can create coupon/discounts to offer to customers. The coupon information entry step 690 may comprise the following data input parameters: an input coupon image selection; a coupon code input box; a discount information input box; an offer start time input box; an offer close time input box; and a publish date selection.

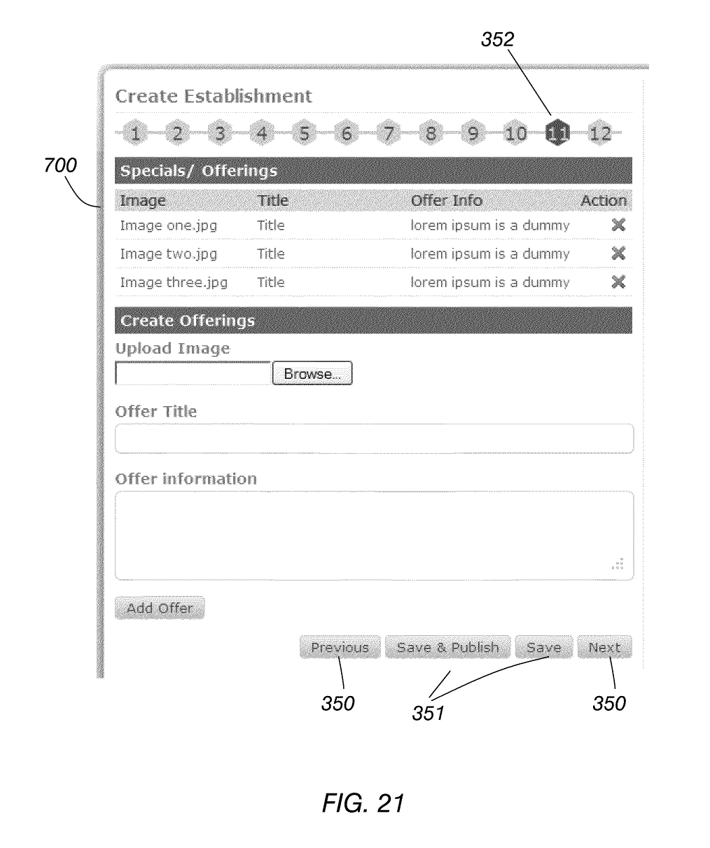

FIG. 21 illustrates a special offerings entry step 700. In this step, the establishment partner can add specials or offerings of the establishment. The special offerings input step 700 may comprise the following data input parameters: an input offerings image selection; an offer title input box; and an offer information input box.

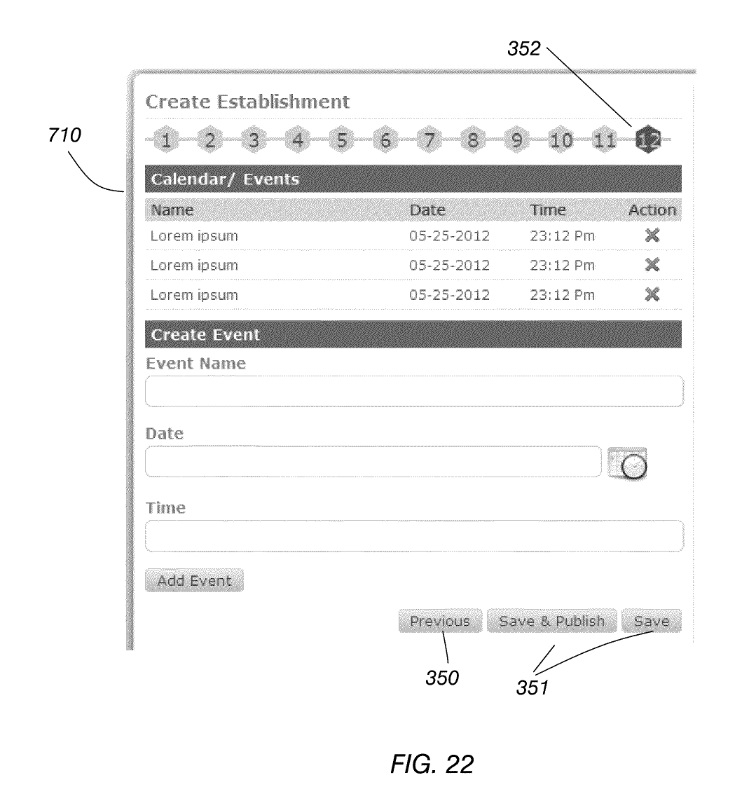

FIG. 22 illustrates a calendar of events information input step 710. In this step, an establishment partner can post events which are occurring or planned at the establishment. The calendar of events information input step 710 may comprise the following data input parameters: an event name input box; a date selection; and a time selection. The establishment host or establishment partner can add/delete multiple events and these are listed as shown.

Groups can be formed on the social networking system 201, with relevant information provided by a group host through one or more of such web-based templates. The social networking system receives 103 the information provided by the host pertaining to the resource object 102 being created.

The social networking system 201 provides 105 a website on a communications device of an end-user 105a based on information obtained in the web-based templates (i.e. resource information 713, amended resource information 712) and content data 711 provided by other users. The websites contain relevant data to the particular event, group, or establishment. The websites may be an event user display interface 250 (in the case of an event resource object), an establishment user display interface 440 (in the case of an establishment), a group user display interface 850 (in the case of a group), or similar interfaces.

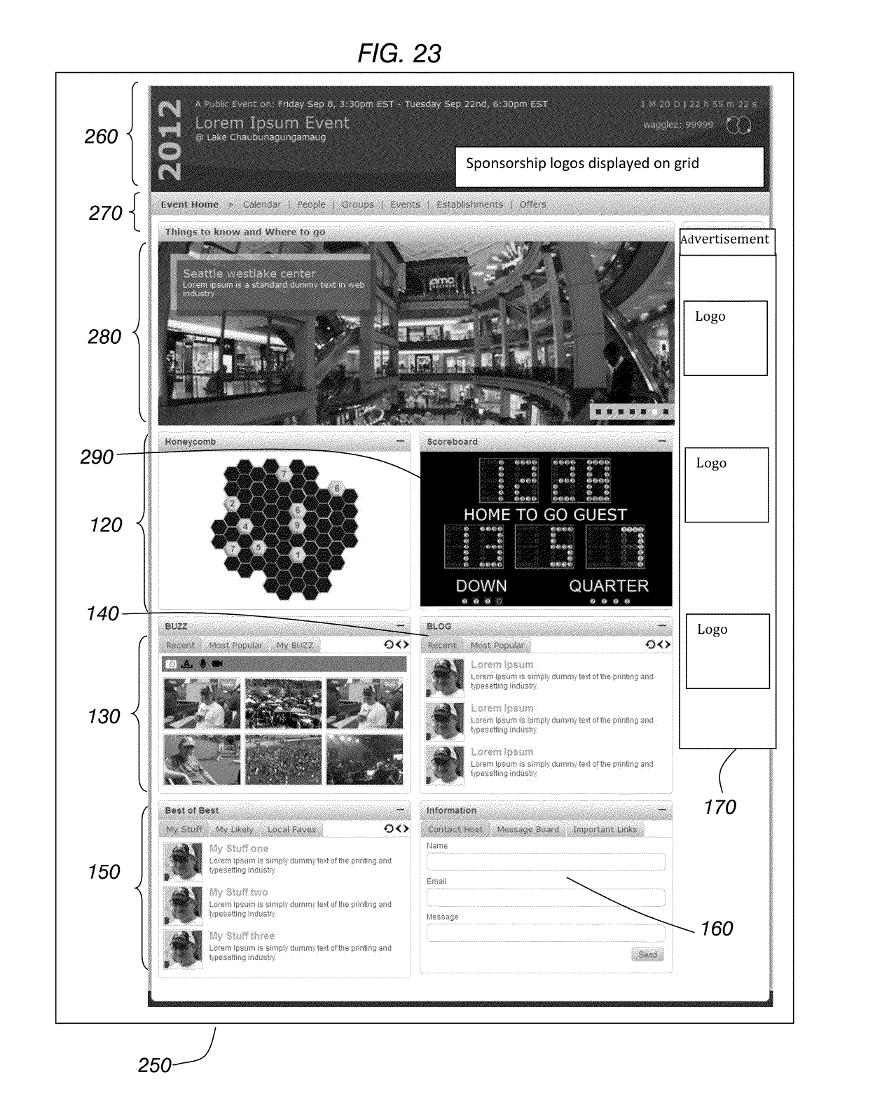

FIG. 23 illustrates a screenshot of an event user display interface 250 As shown, an event user display interface comprises an event top banner 260; an event secondary navigation bar 270; an event slideshow section 280; a resource display interface 120; an event widget section 290; a buzz section 130; a blog section 140; a best of the best section 150; an information section 160; and an advertisement section 170.

The event top banner 260 displays event information such as: event type, date(s) and time of the event, event name, event location, countdown to start/countdown to end, number of wagglez and an option to waggle the event. The event top banner also displays an arrangement of sponsor logos (if any) of the event.

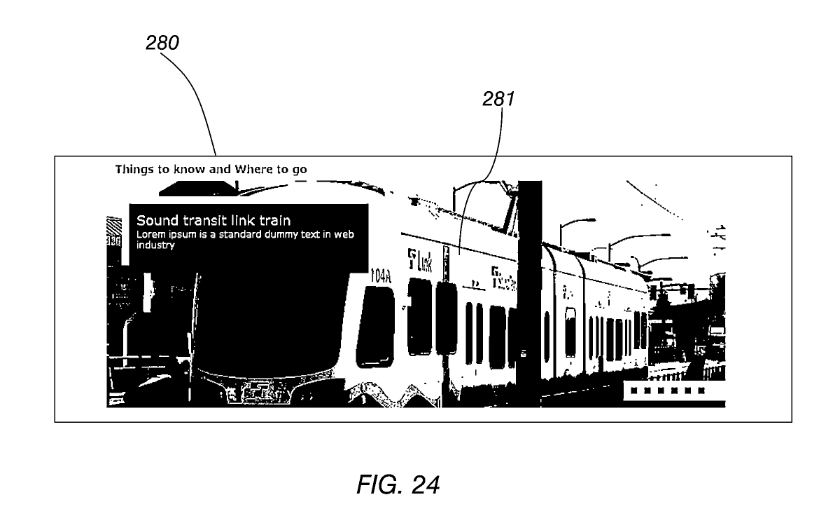

FIG. 24 illustrates a screenshot of the event slideshow section 280. In this section, a slide show of the event images 281 uploaded by the event host is displayed. A title and content for each image is displayed along with the image.

FIG. 25 illustrates a screenshot of the event widget section 290. In this section, a widget 291 selected by the event host is displayed. A widget 291 is a graphical interface displaying real-time data relating to the type of event hosted. In the example shown, a scoreboard widget is displayed for reference (an associated event may be a basketball game viewing party, for example). However other types of widgets are contemplated. For example, an astronomy watch group may display telemetry data and a corresponding sky cart based on this information, which is provided by a third-party in real-time.

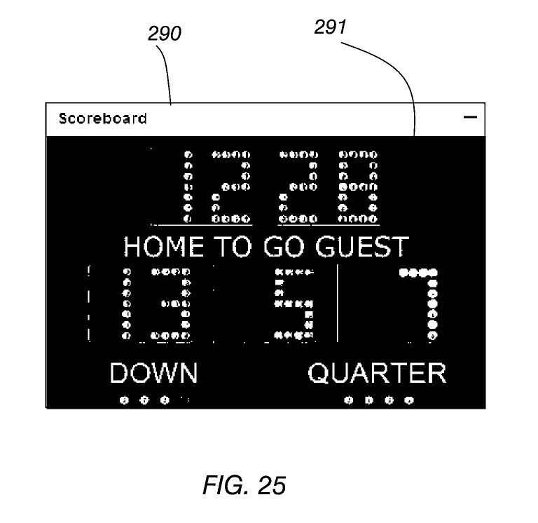

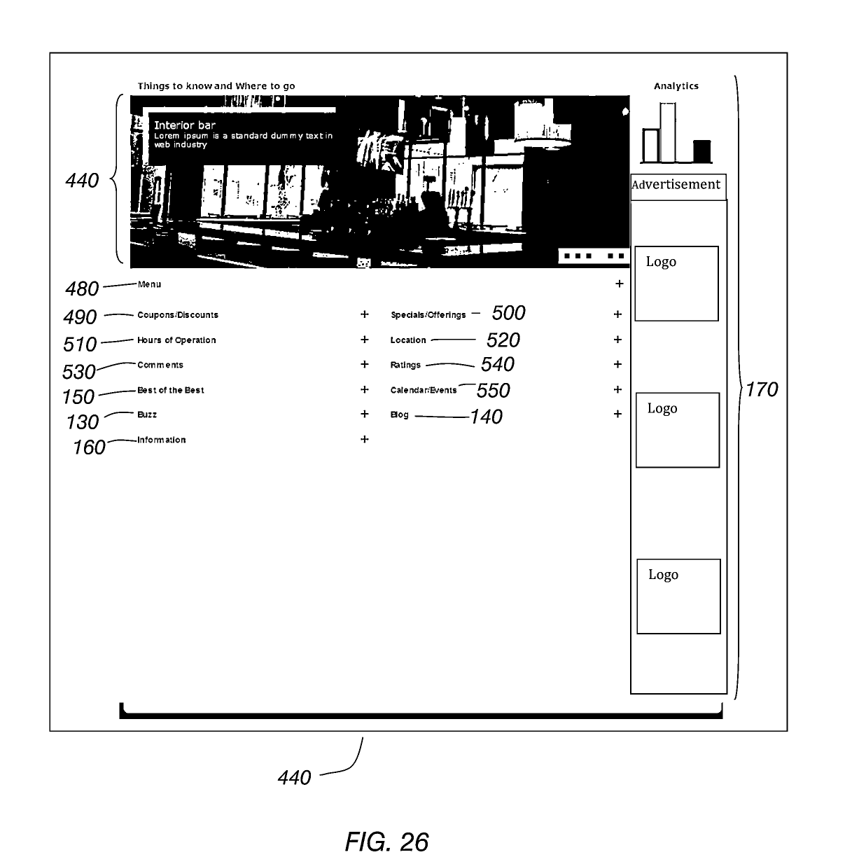

FIG. 26 illustrates a screenshot of the establishment user display interface 440. As shown, an establishment user display interface comprises an establishment top banner 450; an establishment secondary information bar 460; an establishment slideshow section 470; a menu section 480; a coupon section 490; a special offering section 500; an hours of operation section 510; an establishment location section 520; a comments section 530; a ratings section 540; a buzz section 130; a calendar of events section 550; an blog section 140; a best of the best section 150; an information section 160; and an advertisement section 170.

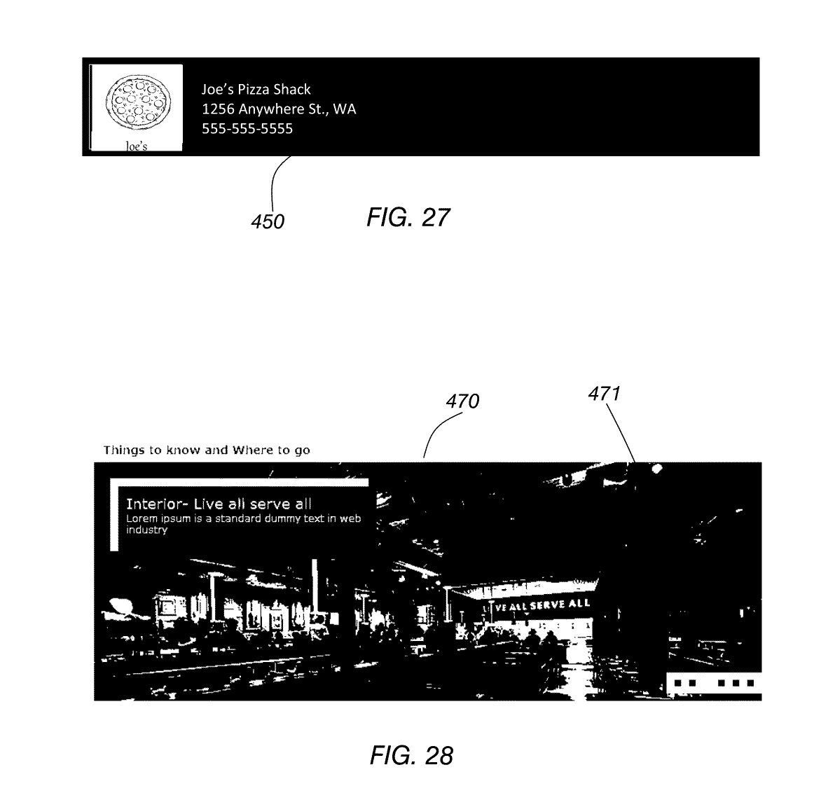

FIG. 27 illustrates a screenshot of the establishment top banner 450. The establishment top banner 450 displays establishment information such as: logo 451; establishment name 452; and establishment address 453.

FIG. 28 illustrates a screenshot of the establishment slideshow section 470. In this section, a slide show of the images 471 uploaded by the establishment host is displayed. A title and content for each image is displayed.

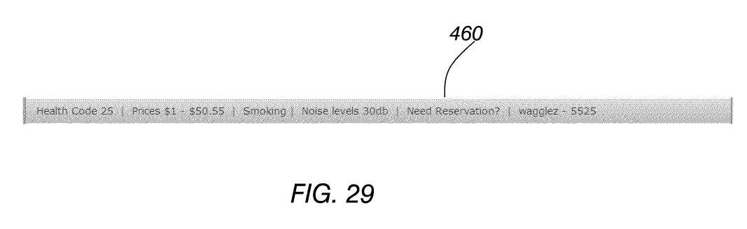

FIG. 29 illustrates a screenshot of the secondary information bar 460. The secondary information bar may display establishment information such as: health code rating; price; smoking or non-smoking information; noise level; reservation required information; wait time; cleanliness ratings; and number of wagglez.

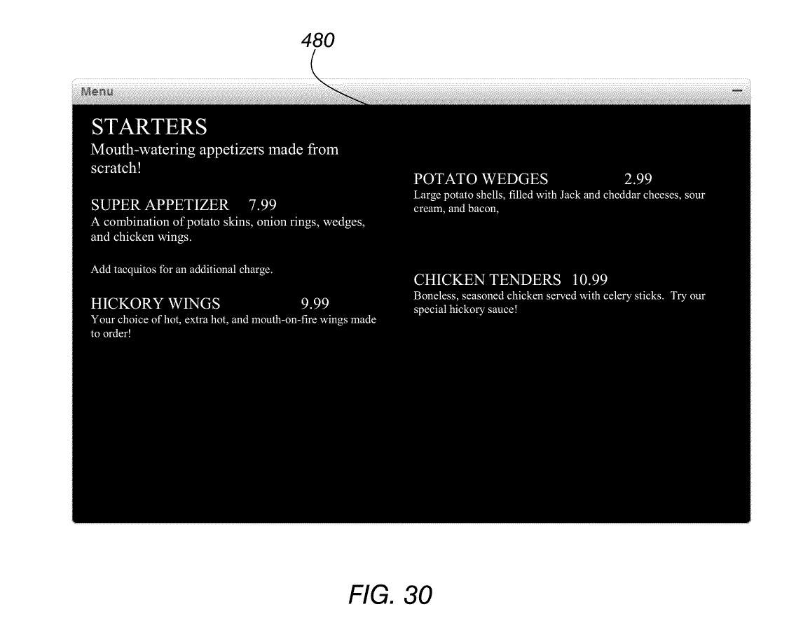

FIG. 30 illustrates a screenshot of the menu section 480. In this section, the information related to the items sold by the establishment is displayed. In the case of a restaurant type establishment, for example, food items are displayed. The menu section 480 may display establishment menu information such as: item picture; item name; item description; unit measurement; and price.

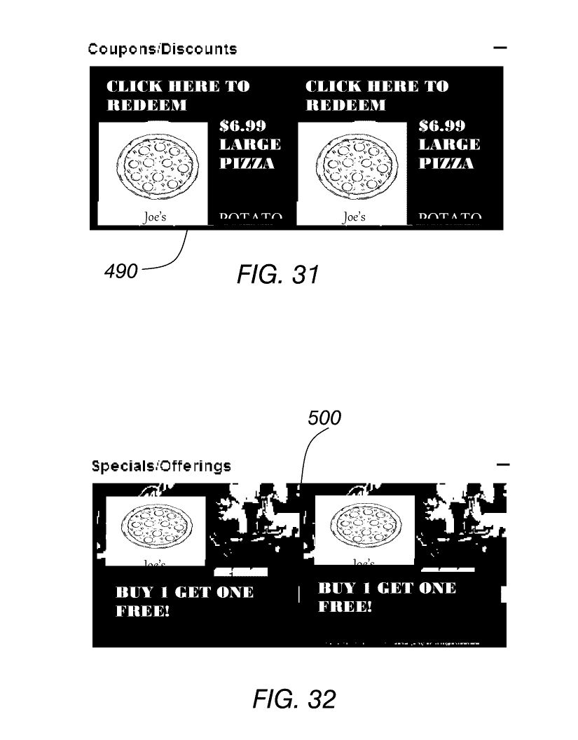

FIG. 31 illustrates a screenshot of the coupons section 490. In this section, the coupons or discounts offered by the establishment are displayed. Users 101 can redeem the coupons.

FIG. 32 illustrates a screenshot of the special offerings section 500. In this section, the specials and/or offerings posted for the establishment are displayed.

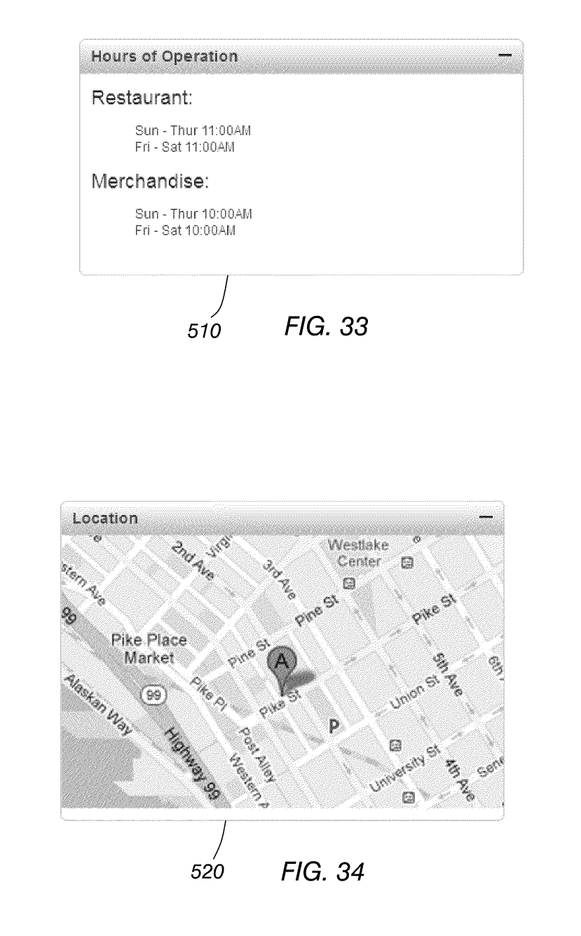

FIG. 33 illustrates a screenshot of the hours of operation section 510. In this section, the hours of operation of the establishment are displayed.

FIG. 34 illustrates a screenshot of the establishment location section 520. In this section, the establishment location is displayed on a map based on the geo coordinates entered by the establishment host.

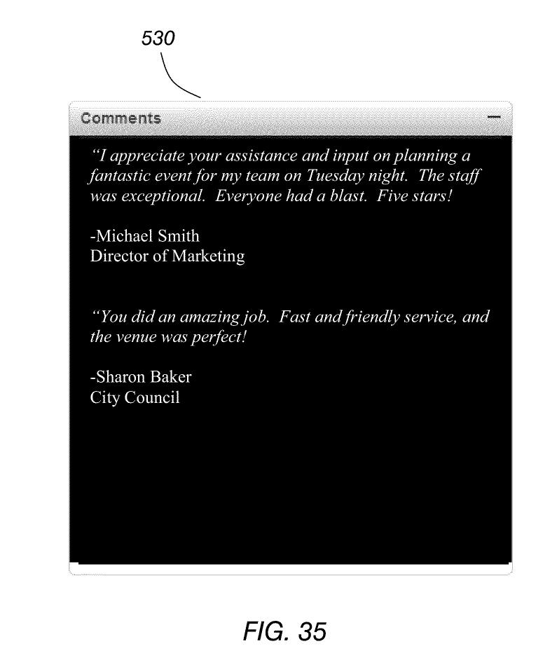

FIG. 35 illustrates a screenshot of the comments section 530. In this section, users 101 may post comments relating to the establishment. All the posted comments are displayed in reverse chronological order.

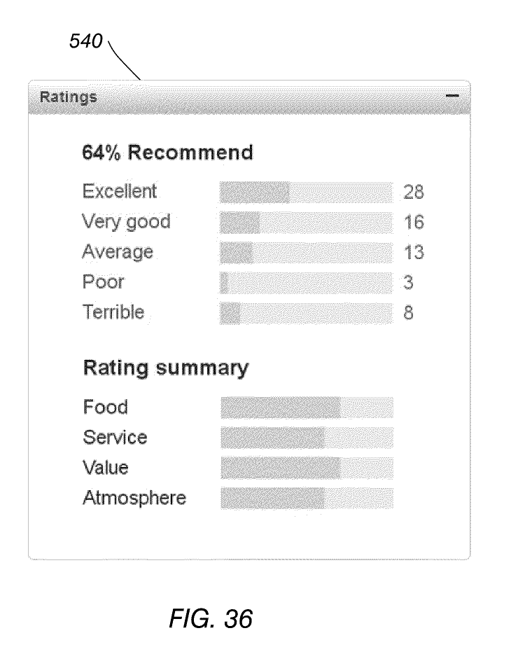

FIG. 36 illustrates a screenshot of the ratings section 540. In this section, rating information of an establishment is displayed. As shown, the general rating parameters can qualitative ratings of the establishment, such as: excellent; very good; average; poor; or terrible. The specific rating parameters for different types of establishment are displayed. For a typical restaurant type establishment, the parameters are food, service, value, and atmosphere.

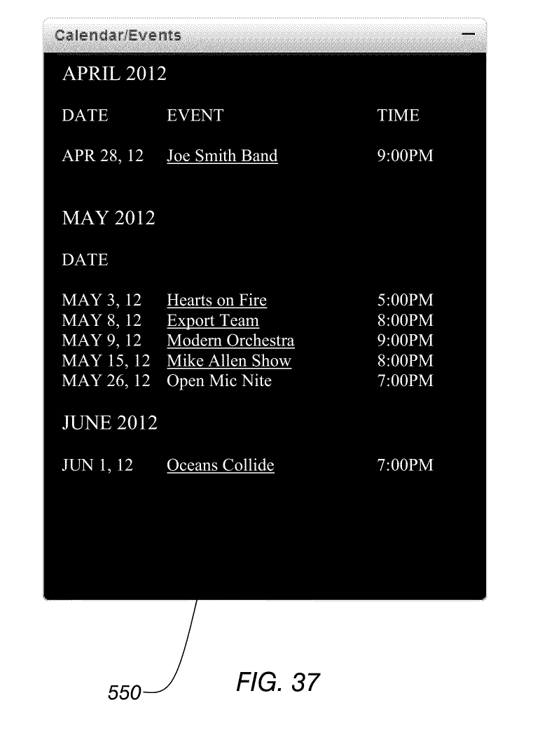

FIG. 37 illustrates a screenshot of the calendar of events section 550. In this section, the event schedules that are planned at the establishment are displayed. The calendar may be interactive, and will display the information in monthly chronological order.

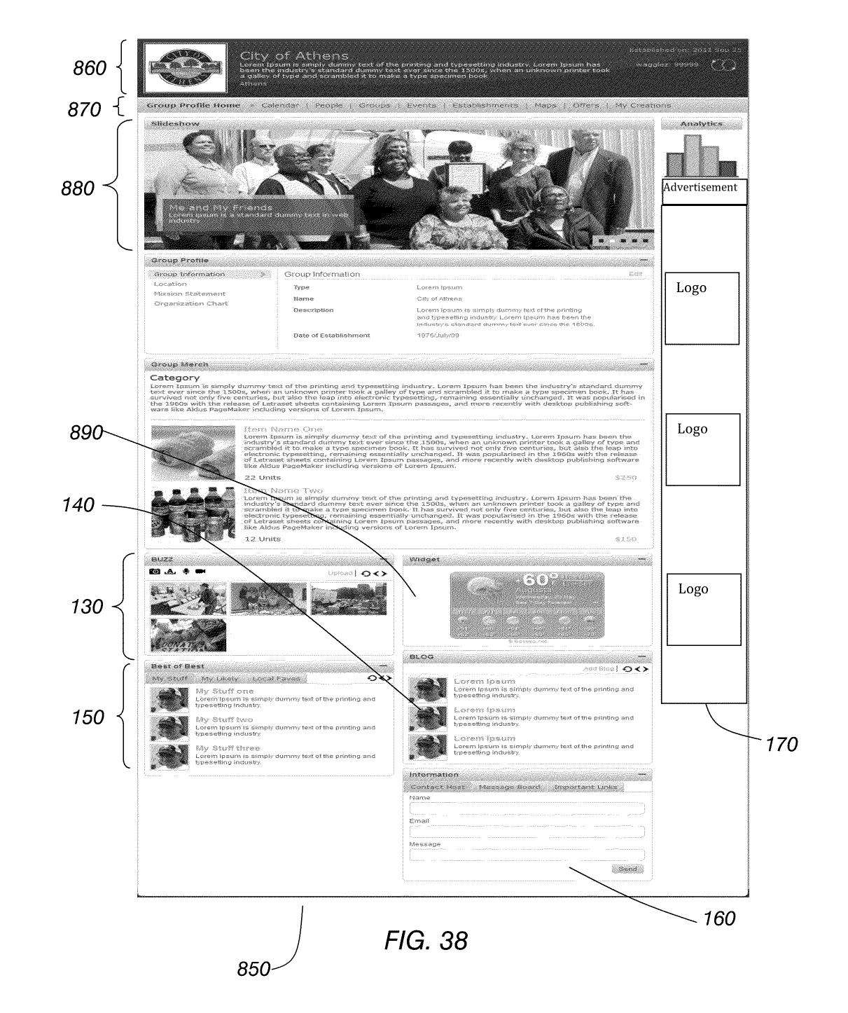

FIG. 38 illustrates a screenshot of a group user display interface 850 As shown, a group user display interface comprises a group top banner 860; a group secondary navigation bar 870; a group slideshow section 880; a resource display interface 120; an group widget section 890; a buzz section 130; a blog section 140; a best of the best section 150; an information section 160; and an advertisement section 170.

The social networking system 201 provides 106 access for end-users to access resource objects 201 through the one or more real-time interface components displayed on websites. For example, the real-time interface components may be either of: a resource display interface 120; a buzz section 130; a blog section 140; an information section 150; a best-of-the best section 160; an advertisement section 160; or an advertisement section 170.

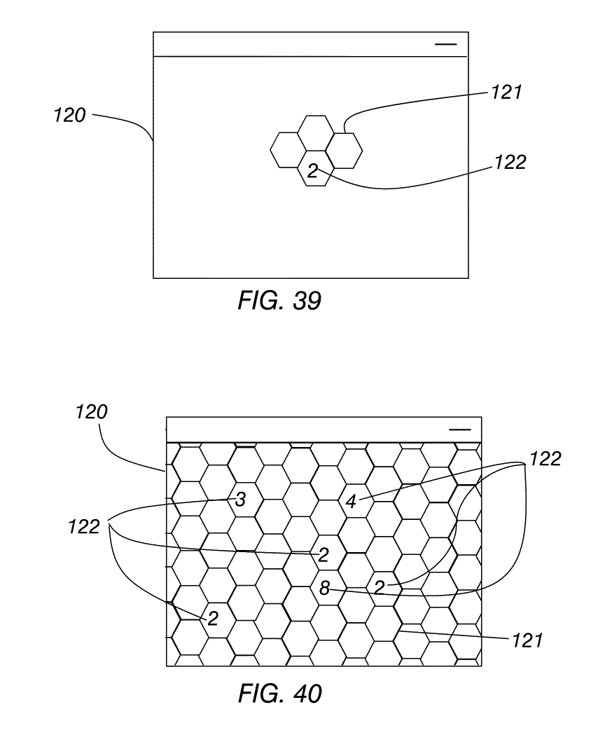

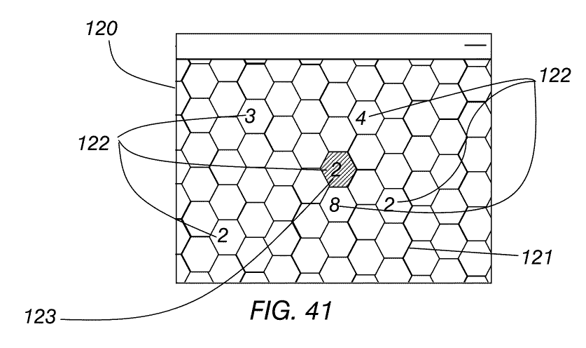

FIGS. 39-41 illustrate a resource display interface 120. A resource display interface 120 is a graphical user display of the quantity and/or changes of resource object associations 714 and mean traffic data as to one or more resources objects 202 (such as events, groups, establishments, and/or interests). Resource display interface 120 is a scalable tessellation of one or more resource display members 121. Real-time signal notification according to user preferences may be displayed on the resource display interface 120.

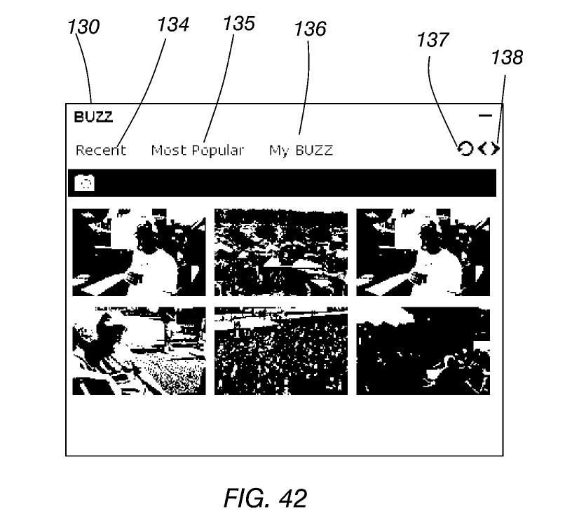

FIG. 42 illustrates a screenshot of the buzz section 130. In this section, recent and most popular pictures, text messages, audios, videos uploaded for a particular user, event, establishment, or group are displayed. When a particular image is selected, a slideshow displays the pictures uploaded. In the recent sub-section 134, the latest items (pictures, texts, audios, videos) are displayed. In the most popular sub-section 135, most accessed items (pictures, texts, audios, videos) are displayed, with the highest accessed listed first. In the my buzz sub-section 136, the pictures, text messages, audios, videos uploaded for a particular user, event, establishment, or group are displayed. The user can access the latest listings by clicking the refresh icon 137 located at the top right corner of the section. The user can navigate and access the full listing of the items (pictures, texts, audios, videos) by using left and right arrow icons 138 located at the top right corner of the section.

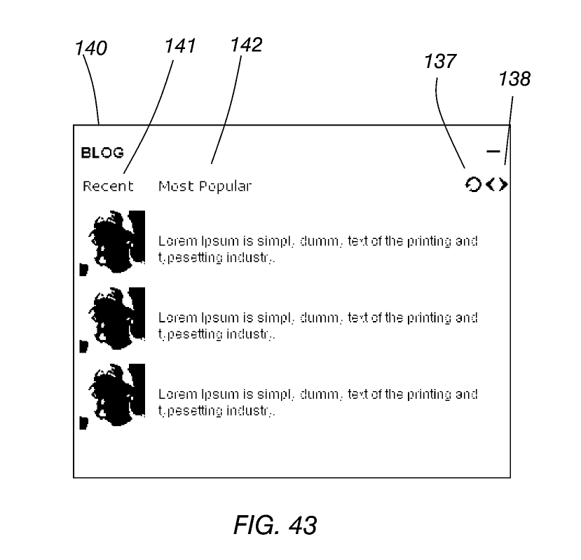

FIG. 43 illustrates a screenshot of the blog section 140. In this section, recent and most popular blogs posted for a particular user, event, establishment, or group are displayed. The difference between the recent 141 and most popular heading 142 selections is time posted, as opposed to most viewed/accessed. A user can access the latest blogs by clicking the refresh icon 137 located at the top right corner of the section. A user can navigate and access the full listing of the blogs by using left and right arrow icons 138 located at the top right corner of the section.

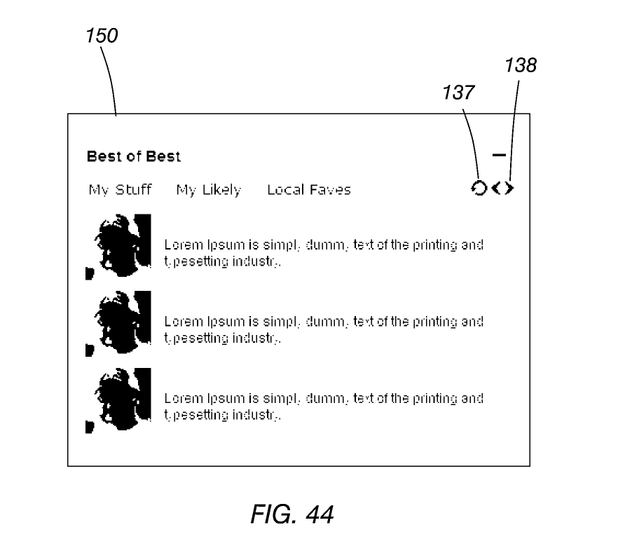

FIG. 44 illustrates a screenshot of the best of the best section 150. This section is visible only if the user is logged in. In this section, information related to the logged in user is displayed. A user can access the latest information by clicking the refresh icon 137 located at the top right corner of the section. A user can navigate and access the full listing by using left and right arrow icons 138 located at the top right corner of the section.

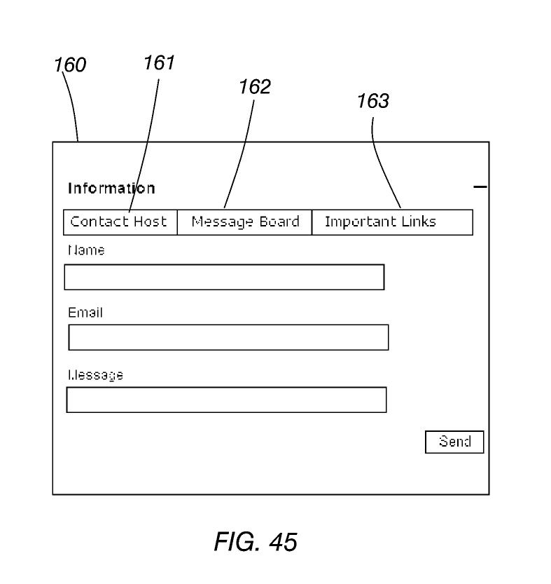

FIG. 45 illustrates a screenshot of the information section 160. In this section, a contact sub-section 161, a message board sub-section 162, and an important links sub-section 163 are displayed. A user can contact other users by providing the following information: name; email address; and message (a query or comment). After providing the information is sent via email/notification to another user with the submitted details. The message board sub-section 162 is a forum where users can post a message/query and view the messages already posted. URLs with a title are displayed in the important links sub-section 163.

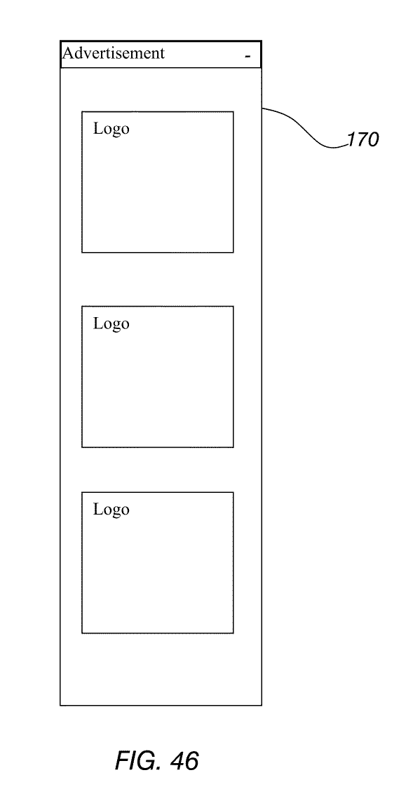

FIG. 46 illustrates a screenshot of the advertisement section 170. Text, picture, and advertisements are displayed. The order of the advertisements display is based on the highest bid amount paid by the advertiser.

The social networking system may allow for a number of corporate sponsors to bid via silent auction for advertising space on the websites generated from the web-based templates. For example, 6 corporate sponsors could be allowed per an event, and one per establishment. A sponsorship could provide a hyperlinked logo which can be 88×31 IMU (i.e., a 88×31 pixel microbar) displayed for the duration of the event. The social networking system may also allow for advertisers to purchase logo placement on a website generated by web-based templates. Advertisements could be purchased according to several models, including: CPM (“Cost per Mille”); CPV (“Cost per View”); CPC (“Cost Per Click”); and/or CPA (“Cost Per Action”).

The social networking system 201 determines 107 resource object profit for a particular resource object 202. Resource object profit for a particular resource object is determined by assessing the revenue generated from sponsorships and advertising for a particular resource object and subtracting the operational cost allocated to that resource object. Operational cost per resource object is computed as a ratio between the entire network activity and the network activity for the particular resource object.

For example, an event may generate a fixed dollar amount from bids placed by event sponsors, and ads purchased by advertisers. If it is determined that activity for the entire social networking site is 100 posts per second and activity for the resource object is 25 posts per second—then the operational cost per resource object would be one-fourth (¼th) of operational cost for the entire social networking system. The resource object profit could then be determined by subtracting the operational cost per resource object by the revenue generated.

The social networking system 201 determines 108 the amount payable to a host for creating the resource object 202. In the preferred embodiment, an event host may receive fifty-percent (50%) of profit generated for a resource object amount for providing the information through the web-based templates which create the event on the social networking system. The host may also be paid fifty-percent (50%) of the partnership subscription fees. Payment may be completed using a number of means, such as online payment systems, wire transfer, or direct deposit.

### Environment of the Social Networking System

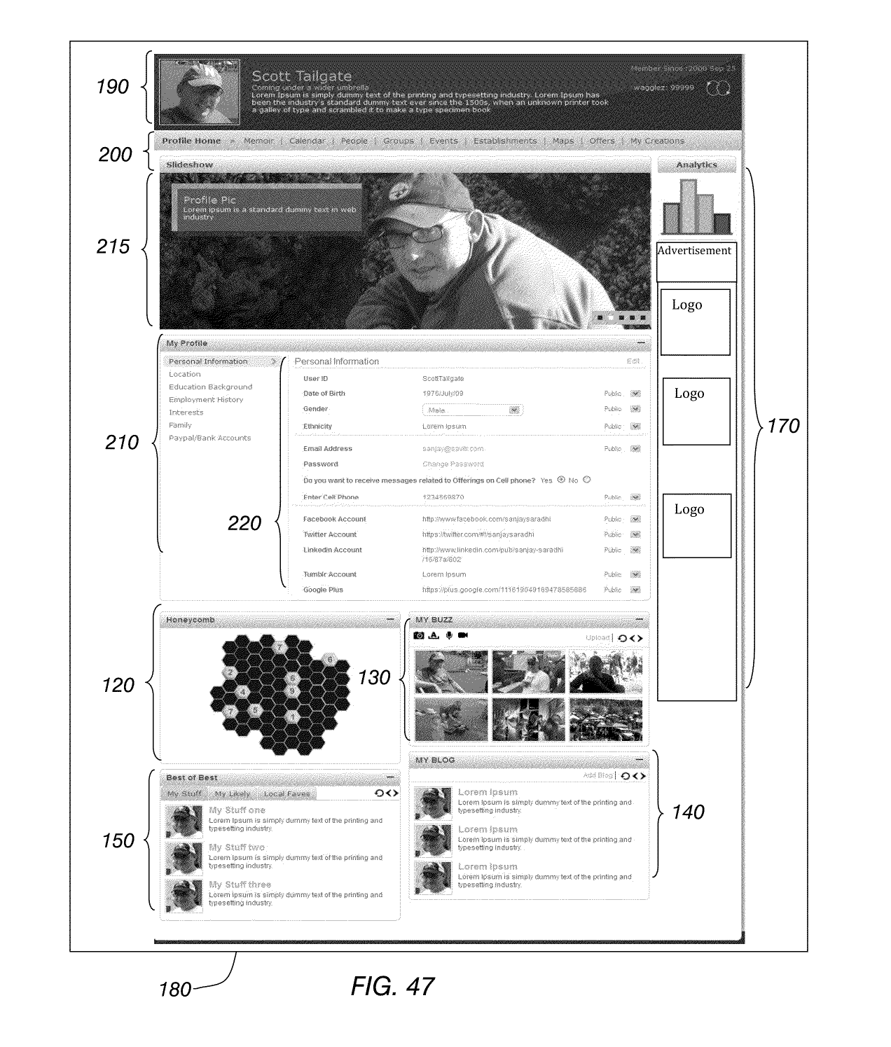

Users can create profiles on the social networking system 201. Upon registration, registered users can provide user specific information, such as name, date of birth, gender, address, notifications, address, email, and user ID, displayed in the user profile interface 180, as illustrated in FIG. 47.

FIG. 47 illustrates a screenshot of a user profile interface 180. The user profile interface may contain information about a particular user and one or more interactive widgets. The user profile interface 180 as shown comprises: a user top banner 190; a user navigation bar 200; a user information navigation section 210; a user slideshow section 215; a user information display section 220; a resource display interface 120; a buzz section 130; a blog section 140; a best of the best section 150; and an advertisement section 170.

Users can choose to associate with events, groups, other users, or establishments on the social networking system 201. Users can also provide a resource signal selection for a resource object, referred to as a “waggle” (with the term “wagglez” referring to the plural form), to other users on the social networking system 201. For example, users attending real-time events may “waggle” such an event. The “waggle” would signal to other users of increased activity in such an event which users have in common, and would notify other users via one or more graphical displays.

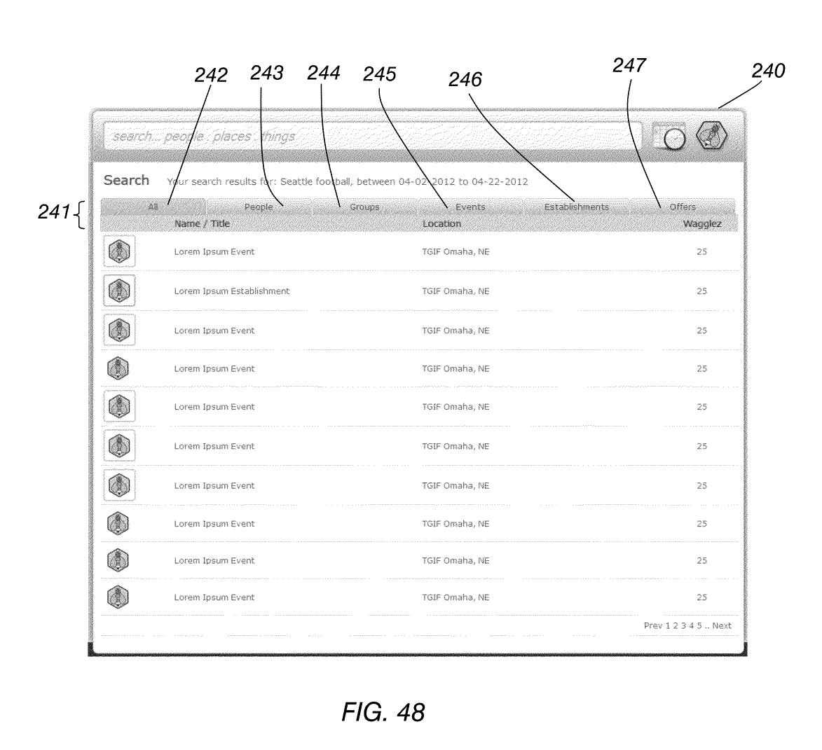

A user can search for groups, events, users, and establishments in a search interface 240. FIG. 48 illustrates a screenshot of the search interface 240. A search engine (not shown) will query the entered search strings against search terms configured for the groups, events, and establishments, and will display the results, if any. The user can also search events occurring between a date ranges or on a particular date. As shown in FIG. 240, the search interface 240 includes a navigation bar 241 having one or more search tabs. As shown in FIG. 48, the navigation bar 241 comprises: an all tab 242; a people tab 243; a groups tab 244; an events tab 245; an establishments tab 246; and an offers tab 247 selectable by the user.

Upon selection of the all tab 242, all the matching information with the entered search string is listed. These may include people, groups, events, establishments and offers. Each type may be identified by a color border shown for the image of the respective piece of information. For example, an event image is displayed with a yellow border. The results list will display the event image, name of the object, location, and number of wagglez associated with the object. By default, the number of results displayed will be the default results per page setting. Users can browse the other results by using the page navigation displayed at the bottom right corner of the search results list.

Upon selection of the people tab 243, people matching with the entered search string are listed. These will include a profile image of the registered user (if uploaded), name of the registered user, location (city, state, country) and the number of wagglez. By default, the number of results displayed will be the default results per page setting. Users can browse the other results by using the page navigation displayed at the bottom right corner of the search results list.

Upon selection of the events tab 245, all the events matching with the entered search string are listed. These will include an event image (if uploaded), name of the event, location (address, city, state, country), event date(s) and timings, and number of wagglez.

Upon selection of the establishments tab 246, all the establishments matching with the entered search string are listed. These will include an establishment image (if uploaded), name of the establishment, location (address, city, state, country) and number of wagglez.

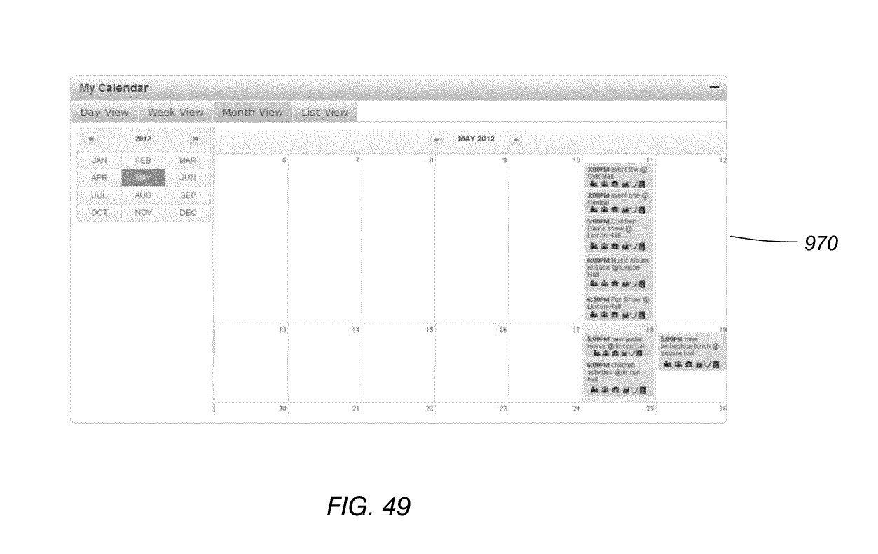

Users on the social networking system 201 can also invite other users to events, groups or establishments created on the social networking system 201. A calendar interface 970 may be displayed for each user showing the time and location of each of said events groups or establishments. FIG. 49 illustrates a screenshot of a calendar interface displayed on a communications device of a user 205a.

### System Architecture

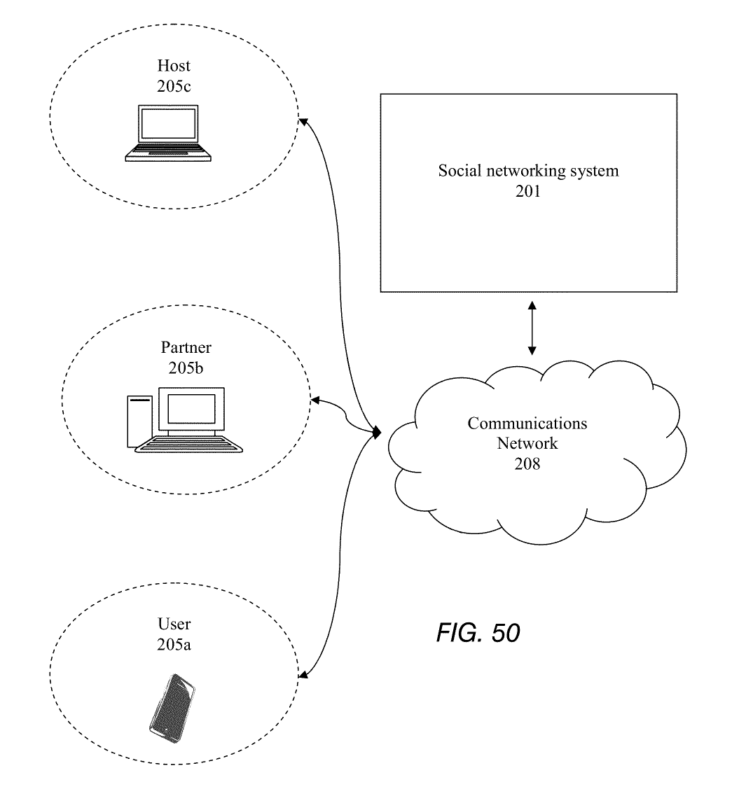

FIGS. 50-52 illustrate a system for generating a customizable interface for creation of a group, event, or establishment based on information provided by users associated with a social networking system and allowing such users to share in profits generated through sponsorships and advertising. Several of the functional components described are labeled as modules (e.g. modules 154, 156) in order to more particularly emphasize their implementation independence. For example, a module may be implemented as a hardware circuit comprising VLSI circuits or gate arrays, logic chips, transistors, or other discrete components. A module may also be implemented in programmable hardware devices such as field programmable gate arrays, programmable array logic, and/or programmable logic devices.

Modules may also be implemented in software for execution by various types of processors. A module of executable code may comprise one or more physical or logical blocks of computer instructions, which may be organized as an object, procedure, or function.

A module of executable code may be a single instruction, or may be many instructions, and may be distributed over several different code segments, among different programs, and across several memory devices. Operational data may be organized with any suitable type of data structure. The operational data may be collected as a single data set, or may be distributed over different locations including over different storage devices. Modules are capable of communication with other modules and databases on the social networking system 201. Modules may receive or provide instructions to other modules or databases on the social networking system 201.

Several of the functional components described are labeled as databases (e.g. 155, 157, 158). Databases may comprise computer readable storage medium stored on one or more servers. Databases may maintain data on the social networking system 201 according to one or more data structures or indexes. Databases are capable of communication with other modules and databases on the social networking system 201. Databases may receive or provide instructions to other modules or databases on the social networking system 201.

FIG. 50 illustrates a high-level diagram showing interaction between communications devices of a host 205c, partner 205b, and user 205a, a communications network 208, and a social networking system 201 of the embodiment. Communications devices 205a, 205b, 205c may be computers, laptops, cellular phones, smart phones, tablets, or similar communications devices. The social networking system 201 may comprise a social networking website, one or more servers operating the social networking website, or any other device or application capable of providing social networking services via the communications network 208.

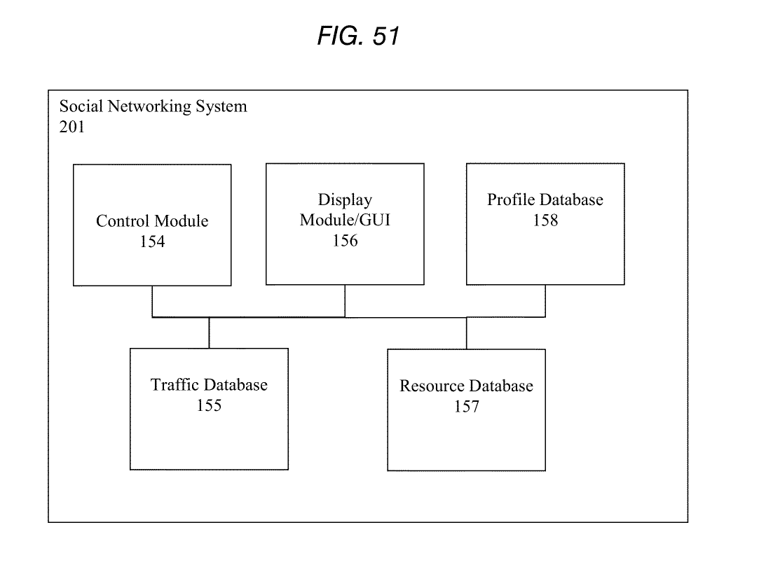

FIG. 51 illustrates a schematic illustration of a social networking system 201. The social networking system has a control module 154, a traffic database 155, a display module 156, a resource database 157, and a profile database 158.

Resource database 157 is provided for storing data pertaining to events, groups, or establishments (resource objects 202) on the social networking system 201. Resource database 157 may create an index of resource objects 202. Each resource object 202 may comprise resource object information 213, amended resource information 212, content data 211, resource object associations 214, as well as type and class of each resource object 202. Resource database 156 may also store information related to sponsorship revenue, advertising revenue, partnership subscription fees, resource object profit, and payment data, as well as information relevant to the host or partner for a particular resource object 202 maintained on the social networking system 201, and maintain an index or data structure of such data.

Profile database 158 is provided for storing data pertaining to individual users. Profile database 158 may create an index of user objects. Each user object may contain personal information about a user (name, email address, location). User objects may also contain user resource associations and user assigned importance, which is stored on the profile database 158.

Traffic database 155 is provided for storing mean traffic data for resource objects 202. Traffic database 155 may create an index, with each index relating to mean traffic data for a particular resource object 202.

Display module 156 is provided for communications with users (including hosts, partners, and end-users) displaying a resource display interface 120 on a communications device of a user 105a. Display module 156 is capable of rendering a graphical user interface viewable by the user. For example, display module 156 may display web pages web based templates, or widgets on a browser of a user communications device 105a, 105b, 105c via TCP/IP, HTTP, or other protocol.

Control module 154 is provided to execute a set of instructions for maintaining a plurality of resource objects 202 on a social networking system 201; displaying one or more web-based templates on a communications device of a host 205c; receiving resource information via the web-based templates; providing one or more web-based templates on a communications device of a partner 205b for receiving amended resource information of a partner who has chosen to associate with the particular resource object 202; displaying one or more graphical user interfaces in user generated websites on a communications device of an end-user 105a based on information obtained in the web-based templates; providing access for end-users to access resource objects 201 through the one or more graphical user interfaces displayed on a communications device of the end-user 205a; determining profit generated for the resource object 202 from sponsorship and advertising for that particular resource object; and determining the amount to be paid to a host creating the resource object 202 according to the preferred embodiment set forth herein. Control module 154 is capable of job/scheduling and sending/receiving instructions to control module 154, a traffic database 155, a display module 156, a resource database 157, and a profile database 158 during execution. Control module 154 is capable of sending/receiving data control module 154, a traffic database 155, a display module 156, a resource database 157, and a profile database 158 during execution.

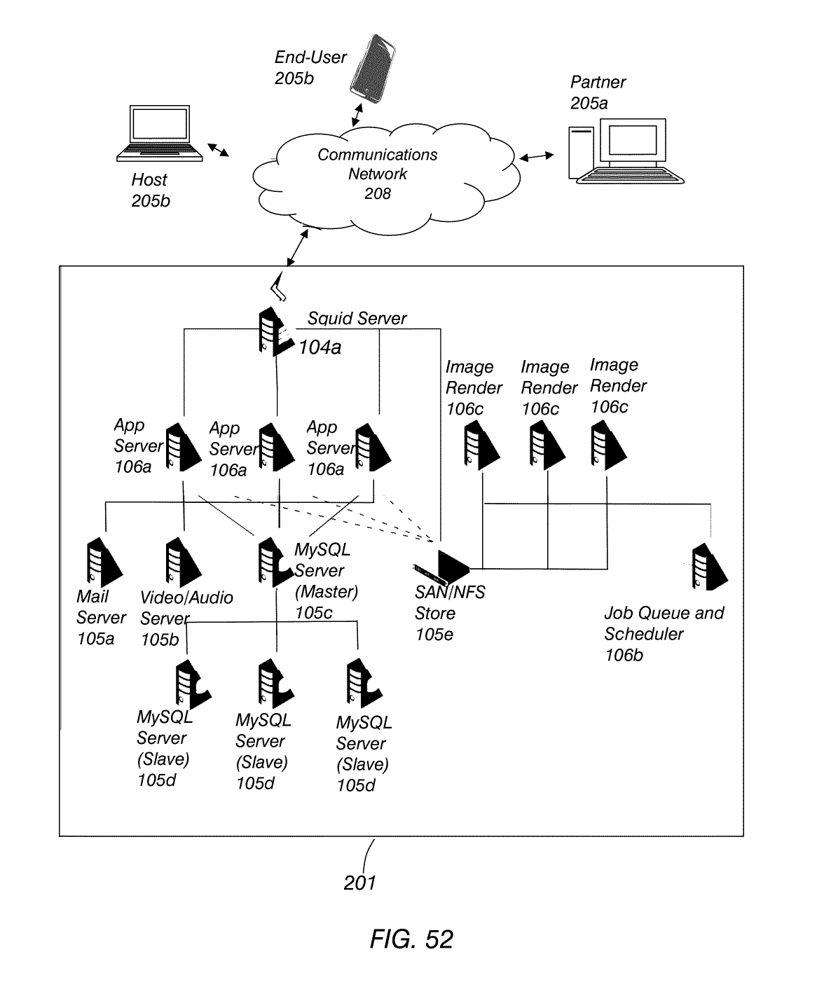

FIG. 52 represents a schematic diagram of detailed view of an exemplary hardware implementation of the social networking system 202. Implementation of the social networking system 202 in such a configuration is shown for illustration, as other configurations are possible. Hardware implementing the control module 154 may comprise a squid server 104a. The squid server 104a is a caching proxy supporting HTTP, HTTPS, FTP, for example. When used in the “HTTPD-accelerator” or reverse-proxy mode, the squid server 104a facilitates setting up multiple application servers that the squid server 104a load balances. The control module 154 may also comprise a job queue and scheduler machine 106b. Hardware implementing the resource database 157, profile database 158, and traffic database 155 may comprise a MySQL master server 105c, and a plurality of MySQL slave servers 105d. Hardware implementing the display module 156 may include a mail server 105a, a video/audio streaming server 105b, a SAN/NFS based store 105e, a plurality of app servers 106a implementing memcached systems, and a plurality of servers implementing image rendering/resizing processes 106c.

Differing combinations and permutations of the embodiments set forth are contemplated by the current invention. Additionally, all functional equivalents are contemplated by the current invention. Therefore, the spirit and scope of the appended claims should not be limited to the descriptions of the preferred versions and alternate embodiments set forth herein.

Any element in a claim that does not explicitly state “means for” performing a specified function, or “step for” performing a specific function, is not to be interpreted as a “means” or “step” clause as specified in 35 U.S.C. §112, ¶6. In particular, the use of “step of” in the claims herein is not intended to invoke the provisions of 35 U.S.C. §112, ¶6.

What is claimed is:

1. A computer implemented method allowing users to create objects for a particular area of interest(s) on a social networking system through one or more web-based templates, and allowing such users to share in profits generated from the creation of such objects, comprising:
maintaining a plurality of resource objects on a social networking system, wherein each of the resource objects represents an event, group, establishment, or other user on the social networking system;
providing a first set of one or more web-based templates on a communications device of a host on the social networking system for creation of a particular resource object on the social networking system, wherein the first set of one or more web-based templates comprises one or more data selections allowing the host to classify the particular resource object as an event, group, or establishment, and wherein the first set of one or more web-based templates further comprises one or more data selections allowing the host to customize the number, arrangement, and type of real-time interface components to be arranged on one or more websites pertaining to the particular resource object;
receiving resource information pertaining to the particular resource object via the first set of one or more web-based templates;
providing a second set of one or more web-based templates on a communications device of a partner associated with the particular resource object;
receiving amended content information pertaining to the particular resource object from the partner associated with the particular resource via the second set of one or more web-based templates;
displaying the one or more websites pertaining to the particular resource object created by the host on a communications device of an end-user, the one or more websites rendered according to the resource information and the amended content information pertaining to the particular resource object;
providing access for the end-users to provide content data through the one or more real-time interface components arranged on the one or more websites pertaining to the particular resource object, wherein the number, arrangement, and type of real-time interface components are displayed according to the arrangement specified in the resource information provided by the host for the particular resource object;
determining a resource object profit for the particular resource object;
determining an amount payable to the host revenue for the particular resource object.

2. The method of claim 1, wherein the first set of one or more web-based templates for creation of an event comprise a number of templates arranged in steps, the steps comprising: an event information entry step; an event formatting information entry step; an event widget selection entry step; an event external blog information entry step; an event message board content information entry step; an event important links information entry step; and an event associations information entry step.

3. The method of claim 1, wherein the first set of one or more web-based templates for creation of an establishment comprise a number of templates arranged in steps, the steps comprising: an establishment information entry step; an establishment secondary information bar entry step; an establishment slideshow information entry step; a menu information entry step; an hours of operation information entry step; an establishment external blog information entry step; an establishment external blog information entry step; an establishment message board content information entry step; and an establishment important links information entry step.

4. The method of claim 1, wherein the first set of one or more web-based templates for creation of a group comprises a number of templates arranged in steps.

5. The method of claim 1, wherein the second set of one or more web-based templates for receiving amended resource information from a partner comprise a number of templates arranged in steps, the steps comprising: a partner information entry step; a coupons information entry step; a special offerings entry step; and a calendar of events information entry step.

6. The method of claim 1, wherein real-time interface components may be either of: a widget; a chat application; a posting message board; or a media posting application.

7. The method of claim 1, wherein sponsorship revenue for the particular resource object is defined by the sum of revenue from one or more corporate sponsors acquiring sponsorship space on the one or more websites pertaining to the particular resource object, and wherein sponsorship space on the one or more websites is defined as one or 88×31 IMU (i.e., a 88×31 pixel microbar) logos arranged in a grid, which are displayed on the one or more websites pertaining to the particular resource object.

8. The method of claim 1, wherein advertising revenue for the particular resource object is defined by the sum of revenue from one or more corporate sponsors acquiring advertising space on the one or more websites pertaining to the particular resource object through one or more website advertising models, and wherein the one or more website advertising models are either of: a CPM (“Cost per Mille”) website advertising model; a CPV (“Cost per View”) website advertising model; a CPC (“Cost Per Click”) website advertising model; or a CPA (“Cost Per Action”) website advertising model.

9. The method of claim 1, wherein the amount payable the host is fifty percent (50%) of resource object profit and fifty-percent (50%) of partnership subscription fees.

10. A system allowing users to create objects for a particular area of interest(s) on a social networking system through one or more web-based templates, and allowing such users to share in profits generated from the creation of such objects, comprising:
a resource database configured to store data pertaining to resource objects on the social networking system;
a profile database configured to store data pertaining to individual users on the social networking system;
a traffic database configured to store mean traffic data for resource objects on the social networking system;
a display interface configured to display web pages, web based templates, or widgets on a browser of a user communications device accessing the social networking system;
a control module configured to execute a set of instructions for:
maintaining a plurality of resource objects on a social networking system, wherein each of the resource objects represents an event, group, establishment, or other user on the social networking system;
providing a first set of one or more web-based templates on a communications device of a host on the social networking system for creation of a particular resource object on the social networking system, wherein the first set of one or more web-based templates comprises one or more data selections allowing the host to classify the particular resource object as an event, group, or establishment, and wherein the first set of one or more web-based templates further comprises one or more data selections allowing the host to customize the number, arrangement, and type of real-time interface components to be arranged on one or more websites pertaining to the particular resource object;
receiving resource information pertaining to the particular resource object via the first set of one or more web-based templates;
providing a second set of one or more web-based templates on a communications device of a partner associated with the particular resource object;
receiving amended content information pertaining to the particular resource object from the partner associated with the particular resource via the second set of one or more web-based templates;
displaying the one or more websites pertaining to the particular resource object created by the host on a communications device of an end-user, the one or more websites rendered according to the resource information and the amended content information pertaining to the particular resource object;
providing access for the end-users to provide content data through the one or more real-time interface components arranged on the one or more websites pertaining to the particular resource object, wherein the number, arrangement, and type of real-time interface components are displayed according to the arrangement specified in the resource information provided by the host for the particular resource object;
determining a resource object profit for the particular resource object;
determining an amount payable to the host revenue for the particular resource object; and
wherein the control module is configured to perform job/scheduling and sending/receiving instructions to the control module, a traffic database,
display module, resource database, and a profile database during execution.

11. The system of claim 10, wherein real-time interface components may be either of: a widget; a chat application; a posting message board; or a media posting application.

12. The system of claim 10, wherein sponsorship revenue for the particular resource object is defined by the sum of revenue from one or more corporate sponsors acquiring sponsorship space on the one or more websites pertaining to the particular resource object, and wherein sponsorship space on the one or more websites is defined as one or 88×31 IMU (i.e., a 88×31 pixel microbar) logos arranged in a grid, which are displayed on the one or more websites pertaining to the particular resource object.

13. The system of claim 10, wherein advertising revenue for the particular resource object is defined by the sum of revenue from one or more corporate sponsors acquiring advertising space on the one or more websites pertaining to the particular resource object through one or more website advertising models, and wherein the one or more website advertising models are either of: a CPM (“Cost per Mille”) website advertising model; a CPV (“Cost per View”) website advertising model; a CPC (“Cost Per Click”) website advertising model; or a CPA (“Cost Per Action”) website advertising model.

14. The system of claim 10, wherein the amount payable the host is fifty percent (50%) of resource object profit and fifty-percent (50%) of partnership subscription fees.

15. An apparatus comprising a machine readable storage memory storing a program having instructions which when executed by a processor will cause the processor to allow users to create objects for a particular area of interest(s) on a social networking system through one or more web-based templates, and allow such users to share in profits generated from the creation of such objects, including instructions for:
maintaining a plurality of resource objects on a social networking system, wherein each of the resource objects represents an event, group, establishment, or other user on the social networking system;
providing a first set of one or more web-based templates on a communications device of a host on the social networking system for creation of a particular resource object on the social networking system, wherein the first set of one or more web-based templates comprises one or more data selections allowing the host to classify the particular resource object as an event, group, or establishment, and wherein the first set of one or more web-based templates further comprises one or more data selections allowing the host to customize the number, arrangement, and type of real-time interface components to be arranged on one or more websites pertaining to the particular resource object;
receiving resource information pertaining to the particular resource object via the first set of one or more web-based templates;
providing a second set of one or more web-based templates on a communications device of a partner associated with the particular resource object;
receiving amended content information pertaining to the particular resource object from the partner associated with the particular resource via the second set of one or more web-based templates;
displaying the one or more websites pertaining to the particular resource object created by the host on a communications device of an end-user, the one or more websites rendered according to the resource information and the amended content information pertaining to the particular resource object;
providing access for the end-users to provide content data through the one or more real-time interface components arranged on the one or more websites pertaining to the particular resource object, wherein the number, arrangement, and type of real-time interface components are displayed according to the arrangement specified in the resource information provided by the host for the particular resource object;
determining a resource object profit for the particular resource object;
determining an amount payable to the host revenue for the particular resource object.

16. The apparatus of claim 15, wherein the first set of one or more web-based templates for creation of an event comprise a number of templates arranged in steps, the steps comprising: an event information entry step; an event formatting information entry step; an event widget selection entry step; an event external blog information entry step; an event message board content information entry step; an event important links information entry step; and an event associations information entry step.

17. The apparatus of claim 15, wherein the first set of one or more web-based templates for creation of an establishment comprise a number of templates arranged in steps, the steps comprising: an establishment information entry step; an establishment secondary information bar entry step; an establishment slideshow information entry step; a menu information entry step; an hours of operation information entry step; an establishment external blog information entry step; an establishment external blog information entry step; an establishment message board content information entry step; and an establishment important links information entry step.

18. The apparatus of claim 15, wherein the first set of one or more web-based templates for creation of a group comprises a number of templates arranged in steps.

19. The apparatus of claim 15, wherein the second set of one or more web-based templates for receiving amended resource information from a partner comprise a number of templates arranged in steps, the steps comprising: a partner information entry step; a coupons information entry step; a special offerings entry step; and a calendar of events information entry step.

20. The apparatus of claim 15, wherein real-time interface components may be either of: a widget; a chat application; a posting message board; or a media posting application.

21. The apparatus of claim 15, wherein sponsorship revenue for the particular resource object is defined by the sum of revenue from one or more corporate sponsors acquiring sponsorship space on the one or more websites pertaining to the particular resource object, and wherein sponsorship space on the one or more websites is defined as one or 88×31 IMU (i.e., a 88×31 pixel microbar) logos arranged in a grid, which are displayed on the one or more websites pertaining to the particular resource object.

22. The apparatus of claim 15, wherein advertising revenue for the particular resource object is defined by the sum of revenue from one or more corporate sponsors acquiring advertising space on the one or more websites pertaining to the particular resource object through one or more website advertising models, and wherein the one or more website advertising models are either of: a CPM (“Cost per Mille”) website advertising model; a CPV (“Cost per View”) website advertising model; a CPC (“Cost Per Click”) website advertising model; or a CPA (“Cost Per Action”) website advertising model.

23. The apparatus of claim 15, wherein the amount payable the host is fifty percent (50%) of resource object profit and fifty-percent (50%) of partnership subscription fees.
